(19) United States
(12) Patent Application Publication
(10) Pub. No.: US 2024/0186824 A1
(43) Pub. Date: Jun. 6, 2024

(54) SELECTION CRITERIA FOR WIRELESS ENERGY HARVESTING PEERS IN CELLULAR NETWORKS

(71) Applicant: QUALCOMM Incorporated, San Diego, CA (US)

(72) Inventors: Alexandros MANOLAKOS, Escondido, CA (US); Ahmed ELSHAFIE, San Diego, CA (US); Sony AKKARAKARAN, Poway, CA (US)

(21) Appl. No.: 18/287,869

(22) PCT Filed: Jul. 13, 2022
(86) PCT No.: PCT/US2022/036973

§ 371 Date: Oct. 20, 2023

(30) Foreign Application Priority Data
Jun. 28, 2021 (GR) 20210100432

(51) Int. Cl. H02J 50/00; H02J 50/20

(52) U.S. Cl. CPC H02J 50/001; H02J 50/20

(57) ABSTRACT

Aspects of the present disclosure include methods and devices for energy harvesting (EH) including an apparatus, e.g., an EH device, an energy transfer (ET) node, and/or a base station. An EH device may be configured to transmit a request for initiating an RF EH operation that may be received by one or more ET nodes and/or the base station, receive one or more responses to the request from the one or more ET nodes, and receive RF energy transmitted by at least one RF ET node selected by the EH device or the base station based on a set of criteria related to one or more of an RF ET node characteristic, an RF ET node connection quality characteristic, a distance characteristic, or a mobility characteristic. A base station may be configured to indicate for the selected RF ET nodes to transmit the RF energy to the EH device.

### CROSS-REFERENCE TO RELATED APPLICATION

This application claims the benefit of Greek Application No. 20210100432, entitled “SELECTION CRITERIA FOR WIRELESS ENERGY HARVESTING PEERS IN CELLULAR NETWORKS” and filed on Jun. 28, 2021, which is expressly incorporated by reference herein in its entirety.

### TECHNICAL FIELD

The present disclosure relates generally to communication systems, and more particularly, to selecting wireless energy harvesting (EH) peers in cellular networks.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects of wireless communication, e.g., 5G NR, some devices (e.g., user equipments (UEs), IoT devices, wearable devices, etc.) are capable of performing EH operations. RF EH operations may provide controllable and constant energy transfer. Different devices may support energy transfer (ET) for different EH architectures of a target EH device, via different time-and-frequency resources, or via different waveforms. Aspects presented herein provide for selection between RF ET peers for an EH operation based on characteristics of at least one of an EH-capable target device (e.g., UE, IoT device, wearable device, etc.) or an ET-capable device (e.g., base station, UE, IoT device, wearable device, etc.).

In an aspect of the disclosure, a method, a computer-readable medium, and an apparatus are provided. The apparatus may be a device at a UE. The device may be a processor and/or modem at a UE or the UE itself. The UE may be configured to transmit a request for initiating an RF EH operation; receive one or more responses to the request; and receive RF energy transmitted by at least one RF ET node selected based on criteria related to one or more of an RF ET node characteristic, an RF ET node connection quality characteristic, a distance characteristic, or a mobility characteristic.

In an aspect of the disclosure, a method, a computer-readable medium, and an apparatus are provided. The apparatus may be a device at a UE. The device may be a processor and/or modem at a UE or the UE itself. The UE may be configured to receive a request to initiate an RF EH operation for an EH capable UE; and transmitting a response indicating a support for the RF EH operation based on an RF ET node characteristic. The UE may further be configured to receive an indication from the EH-capable UE, or a network (e.g., a base station of the network), to transmit the RF energy to the EH capable UE. The UE may also be configured to transmit RF energy to the EH-capable UE (e.g., based on the indication).

In an aspect of the disclosure, a method, a computer-readable medium, and an apparatus are provided. The apparatus may be a device at a base station. The device may be a processor and/or modem at a base station or the base station itself. The base station may be configured to receive a request to initiate an RF EH operation for an EH capable UE; select at least one RF ET node to transfer RF energy to the EH-capable UE based on criteria related to one or more of an RF ET node characteristic, an RF ET node connection quality characteristic, a distance characteristic, or a mobility characteristic; and indicate for the selected at least one RF ET node to transmit the RF energy to the EH-capable UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and UE in an access network.

FIG. 4 is a diagram illustrating components of an example RF EH-capable device.

FIG. 5 is a set of diagrams each illustrating different RF energy harvesting and RF communication architectures for an RF EH-capable device.

FIG. 6 is a diagram illustrating components of an example network.

FIG. 7 is a diagram illustrating a set of time-and-frequency resources for SL communication.

FIG. 8 is a call flow diagram illustrating a UE in communication with a set of RF ET nodes negotiating an EH operation.

FIG. 9 is a call flow diagram illustrating a UE negotiating an EH operation with a set of RF ET nodes via a base station.

FIG. 10 is a call flow diagram illustrating a UE in communication with a particular RF ET node.

FIG. 11 is a diagram illustrating an example first zone ID-based threshold and a second distance-based threshold.

FIG. 12 is a diagram illustrating a zone ID-based distance determination.

FIG. 13 is a set of diagram illustrating a selection of a set of RF ET nodes for an EH-target device.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a diagram illustrating an example of a hardware implementation for an example apparatus.

FIG. 22 is a diagram illustrating an example of a hardware implementation for an example apparatus.

FIG. 23 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

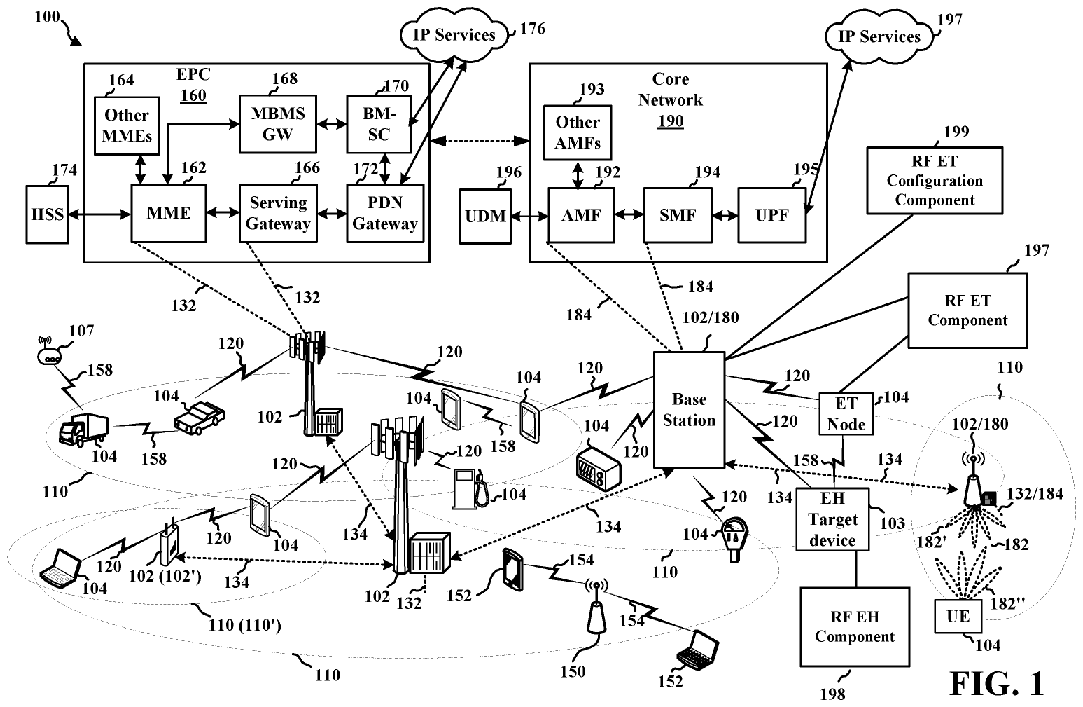

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, an EH target device 103 may include an RF EH component 198 that may be configured to transmit a request for initiating an RF EH operation. The RF EH component 198 may be configured to receive one or more responses to the request and to receive RF energy transmitted by at least one RF ET node selected based on criteria related to one or more of an RF ET node characteristic, an RF ET node connection quality characteristic, a distance characteristic, or a mobility characteristic. The EH target device 103 may be a UE 104 or another device that is capable of receiving an RF signal. In certain aspects, a wireless device that is capable of transmitting an RF signal (e.g., such as a base station 102, 180, UE 104, etc.) may include an RF ET component 197 configured to receive a request to initiate an RF EH operation for an EH capable UE and to transmit a response indicating a support for the RF EH operation based on an RF ET node characteristic. In certain aspects, the base station 102 or 180 may include an RF ET configuration component 199 that may be configured to receive a request to initiate an RF EH operation for an EH capable UE. The RF ET configuration component 199 may be configured to select at least one RF ET node to transfer RF energy to the EH-capable UE based on criteria related to one or more of an RF ET node characteristic, an RF ET node connection quality characteristic, a distance characteristic, or a mobility characteristic and to indicate for the selected at least one RF ET node to transmit the RF energy to the EH-capable UE. Although the following description may be focused on 5G NR, the concepts described herein may be applicable to other similar areas, such as LTE, LTE-A, CDMA, GSM, and other wireless technologies.

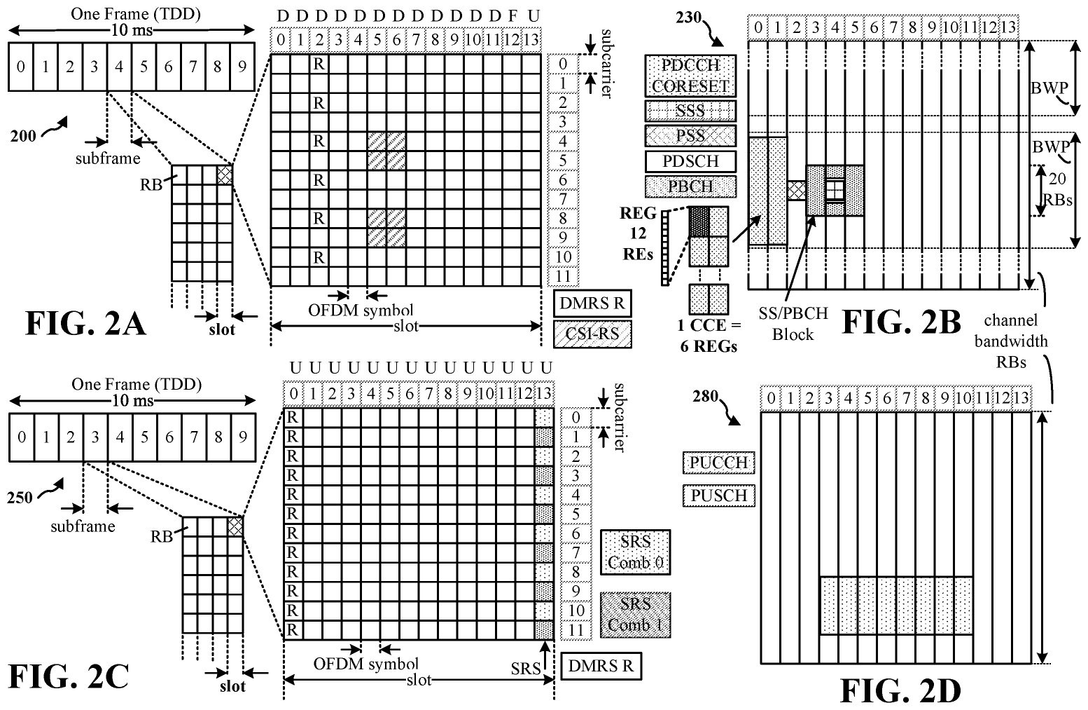

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on whether the cyclic prefix (CP) is normal or extended. For normal CP, each slot may include 14 symbols, and for extended CP, each slot may include 7 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

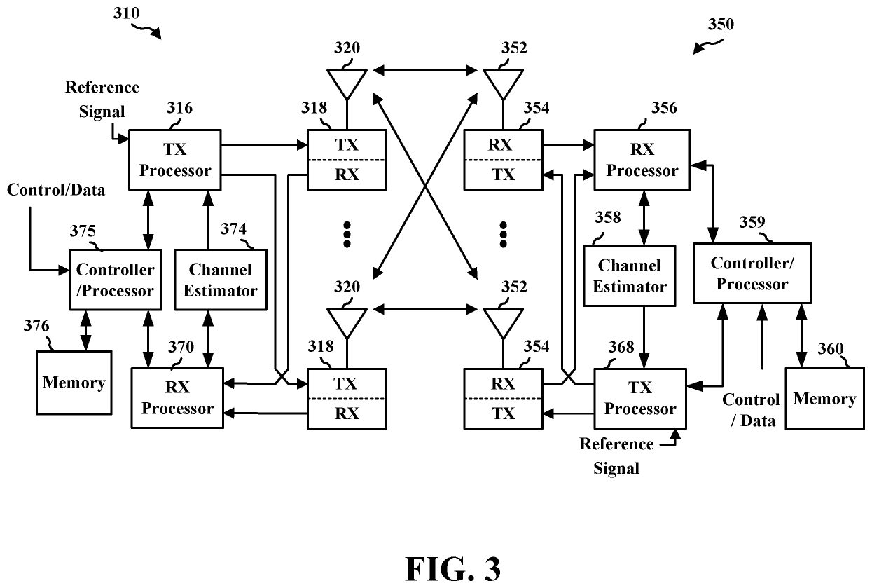

FIG. 3 is a block diagram of a first wireless device 310 in communication with a second wireless device 350, e.g., in an access network. In some aspects, one of the wireless devices may include an EH device that harvests energy from an RF signal received from the other wireless device, as presented herein. In some aspects, one of the wireless devices may be an ET device that transmits an RF signal to the other wireless device as part of an EH operation. In some aspects, one of the wireless devices may be a base station that configures the other wireless device to receive RF energy from an ET device or to transmit RF energy to an EH target device.

The wireless devices may support wireless communication. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. As an example, if the wireless device 310 is a base station and the wireless device 350 is a UE, in the DL, IP packets from the EPC 160 may be provided to a controller/processor 375. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the wireless device 350. Each spatial stream may then be provided to a different antenna 320 via a separate transmitter 318 TX. Each transmitter 318 TX may modulate a radio frequency (RF) carrier with a respective spatial stream for transmission.

At the wireless device 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the wireless device 350. If multiple spatial streams are destined for the wireless device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the wireless device 310. These soft decisions may be based on channel estimates computed by the channel estimator 358. The soft decisions are then decoded and deinterleaved to recover the data and control signals that were originally transmitted by the wireless device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the wireless device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the wireless device 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The UL transmission is processed at the wireless device 310 in a manner similar to that described in connection with the receiver function at the wireless device 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the wireless device 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. At least one of the TX processor 316, the RX processor 370, and the controller/processor 375 may be configured to perform aspects in connection with 198 of FIG. 1.

In some aspects, a wireless device may be capable of transferring or harvesting RF energy. RF energy harvesting may provide controllable and constant energy transfer over distance. In some aspects, the wireless devices may be a wireless communication device that support transferring or harvesting RF energy. For example, in some aspects, an RF signal may be used for communication, and in other aspects the RF signal may be used for energy transfer or energy harvesting. In a fixed RF energy harvesting network, the harvested energy may be predictable and relatively stable over time due to fixed distance. In some aspects, using a random multipath fading channel model, the energy harvested at node j (Eⱼ) from a transmitting node i may be given by Eⱼ=ηPᵢ|gᵢⱼ|²T (Eq. 1), where Pᵢ is a transmit power at node i, gᵢⱼ is a channel coupling coefficient of the link between node i and node j, T is the time allocated for energy harvesting, and η is an RF-to-DC (direct current) conversion efficiency.

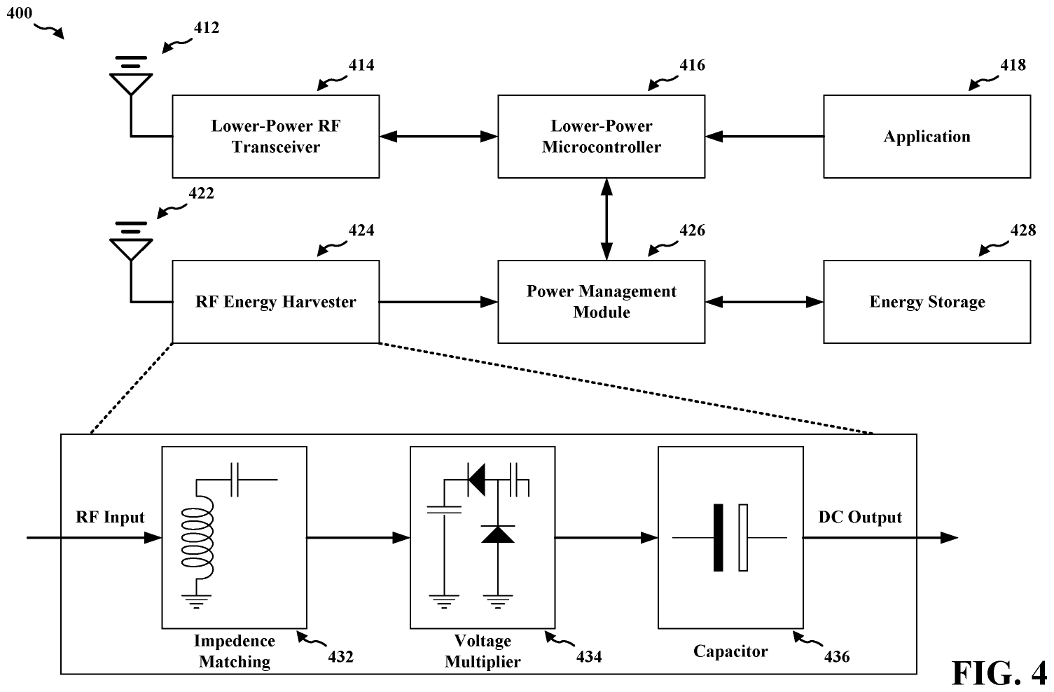

FIG. 4 is a diagram 400 illustrating components of an example RF EH-capable device (e.g., a UE, wearable device, network node, etc.). Diagram 400 illustrates a set of components 412-418 for a data transmission pipeline. Antenna 412 and RF transceiver 414 (e.g., a low power RF transceiver) may transmit and/or receive data. A microcontroller 416 (e.g., a low power microcontroller) may process data received from an application 418.

Diagram 400 further illustrates a set of components 422-428 for an RF-energy-harvesting pipeline. An antenna 422 and an RF energy harvester 424 may harvest RF energy. The RF energy harvester 424 may include an impedance matching circuit 432, a voltage multiplier 434, and a capacitor 436 to collect RF signals and convert them into electricity. A power management module 426 may decide whether to store the electricity obtained from the RF energy harvester 424 or to use it for information transmission immediately. An energy storage 428 (e.g., a battery) may store energy converted by the RF energy harvester 424.

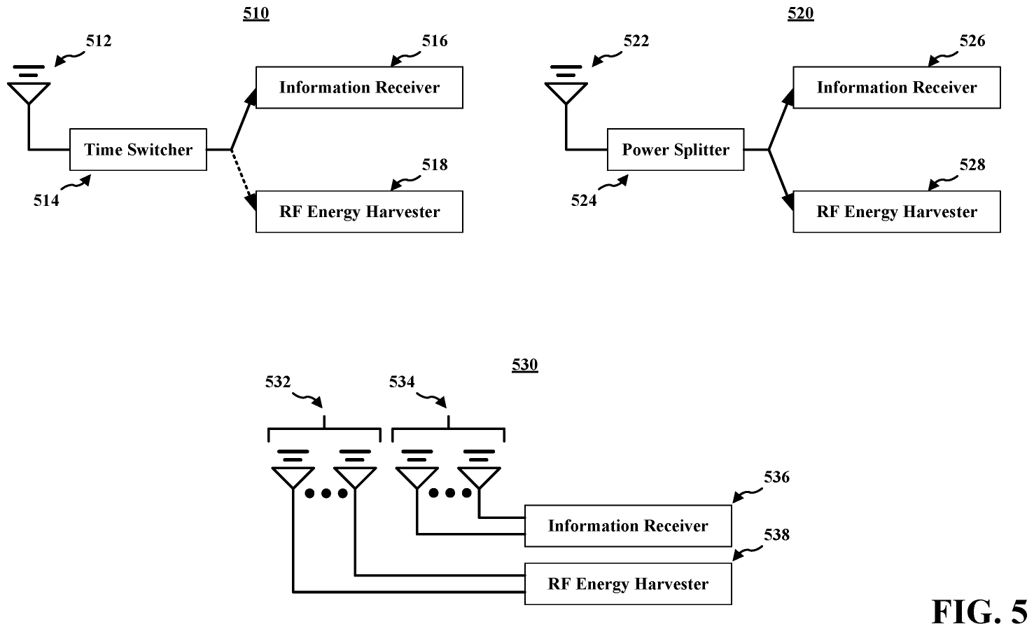

FIG. 5 is a set of diagrams 510-530 each illustrating different RF energy harvesting and RF communication architectures for an RF EH-capable device. Diagram 510 illustrates an antenna 512 connected to a time switcher 514. Time switcher 514 may allow an RF-energy-harvesting-capable device to switch between (1) being connected to an information receiver 516 and (2) being connected to an RF energy harvester 518. For example, the device may exchange wireless communication and RF energy at different, e.g., non-overlapping, times. In a time-switching RF energy harvesting architecture (mode of operation) the energy harvested at a receiver node j (Eⱼ) from a transmitter node i may be given by Eⱼ=ηPᵢ|gᵢⱼ|²αT, where α∈[0,1] is a fraction of time allocated for energy harvesting with other variables defined as in Eq. 1 above described in relation of FIG. 4. Additionally, for a noise spectral density, κ, and a channel bandwidth, W, a data rate (Rᵢⱼ) for communication between a receiver node j from a transmitter node i may be given by

$${R}_{ij} = ( 1 - α ) {log}_{2} ( 1 + \frac{{P}_{i} {\vert {g}_{ij} \vert}^{2}}{κ W} ) .$$

Diagram 520 illustrates an antenna 522 connected to a power splitter 524. Power splitter 524 may allow an RF-energy-harvesting-capable device to distribute power between (1) an information receiver 526 and (2) an RF energy harvester 528. For example, the device may exchange wireless communication and RF energy at overlapping times. A received RF signal may be split into two streams, with one stream for the information receiver and the other stream for the RF energy harvester. In a power splitting RF energy harvesting architecture (mode of operation) the energy harvested at a receiver node j (Eⱼ) from a transmitter node i may be given by Eⱼ=ηPᵢ|gᵢⱼ|²ρT, where ρ∈[0,1] is a fraction of power allocated for energy harvesting with other variables defined as in Eq. 1 above described in relation of FIG. 4. Additionally, for a noise spectral density, κ, and a channel bandwidth, W, a data rate (Rᵢⱼ) for communication between a receiver node j from a transmitter node i may be given by

$${R}_{ij} = {log}_{2} ( 1 + \frac{( 1 - ρ ) {P}_{i} {\vert {g}_{ij} \vert}^{2}}{κ W} ) .$$

Diagram 530 illustrates a separated receiver architecture. A set of antennas 532 is associated with an RF energy harvester 538 while a set of antennas 534 is connected to information receiver 536. For example, diagram 400 illustrates a separated receiver architecture.

As non-limiting examples of waveforms for RF energy transfer, RF energy transfer may occur via one or more of CP-OFDM signals, single carrier FDM (SC-FDM) signals, MIMO-OFDM signals, a deterministic signal (e.g., a pilot signal), a random signal such as a circularly symmetric complex Gaussian random signal, and/or an improper complex Gaussian random signal (e.g., a signal in which Real and Imaginary components have different variances). The RF energy transfer signals, in some aspects, are generated via a pseudo-random generator.

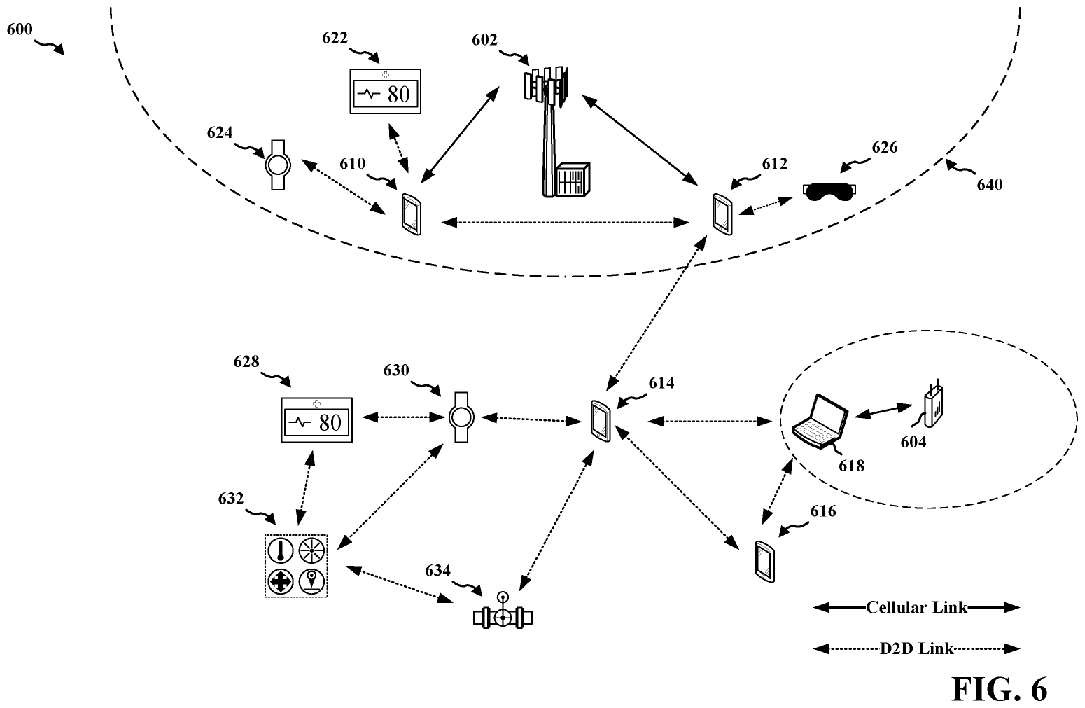

FIG. 6 is a diagram 600 illustrating components of an example network. Diagram 600 illustrates an example network including a base station 602 (e.g., as an example of a base station 102), a small cell base station 604 (similar to small cell 102′ of FIG. 1), a set of UEs 610-618, and other devices 622-634 (e.g., smart devices, sensors, etc.). The UEs 610 and 612 may be in a coverage area of base station 602 and may be in communication with the base station 602. For example, the UEs 610 and 612 may communicate with the base station 602 and may communicate with each other via SL. Resources for SL communication between UE 610 and 612 may be controlled and/or configured by the base station 602. Similarly, the UE 618 (e.g., laptop, or other customer-premises/provided equipment (CPE)) may be connected to the small cell base station 604 via a first type of communication session (e.g., a WiFi connection or Uu connection) and to additional UEs 614 and 616 via a second type of connection (e.g., a SL connection).

The UEs 614 and 616 may be out of a coverage area of the base station 602 and may communicate with each other and/or at least one of UE 610 and 612 via SL. The UE 614 may also be in communication with base station 602 via the UE 612 (e.g., with the UE 612 operating as a relay device) and the additional devices 626-634 via SL, e.g., which may be referred to as partial coverage operation. In some aspects, the connection with the additional devices may be via a Bluetooth™ connection or via an unlicensed spectrum. The SL communication between the UE 614 and the UE 616 may be via pre-configured SL provisioning information for discovery and/or communication support (e.g., pre-configured SL resources) without dynamic input from the base station 602.

In some aspects, one or more of the devices may include a wearable device, sensor, or other device that connects to a network via a UE. As an example, a smartwatch, health monitoring device, or other wearable may exchange communication with a base station via a UE. The wearable may communicate with the UE over sidelink, and the UE may provide a UE to network relay operation. As another example, an extended reality (XR) device may have a sidelink connection with a UE, and the UE may provide a UE to network relay operation for the XR device. As another example, a sensor may exchange communication with a UE (as well as other sensors) via sidelink, and the UE may relay communicate for the sensor with the network. Multiple sensors may communicate, e.g., over sidelink, to form a mesh network using UE to UE relay of communication. As an example, smart home appliances such as a smart thermostat and an entry key may exchange communication over sidelink.

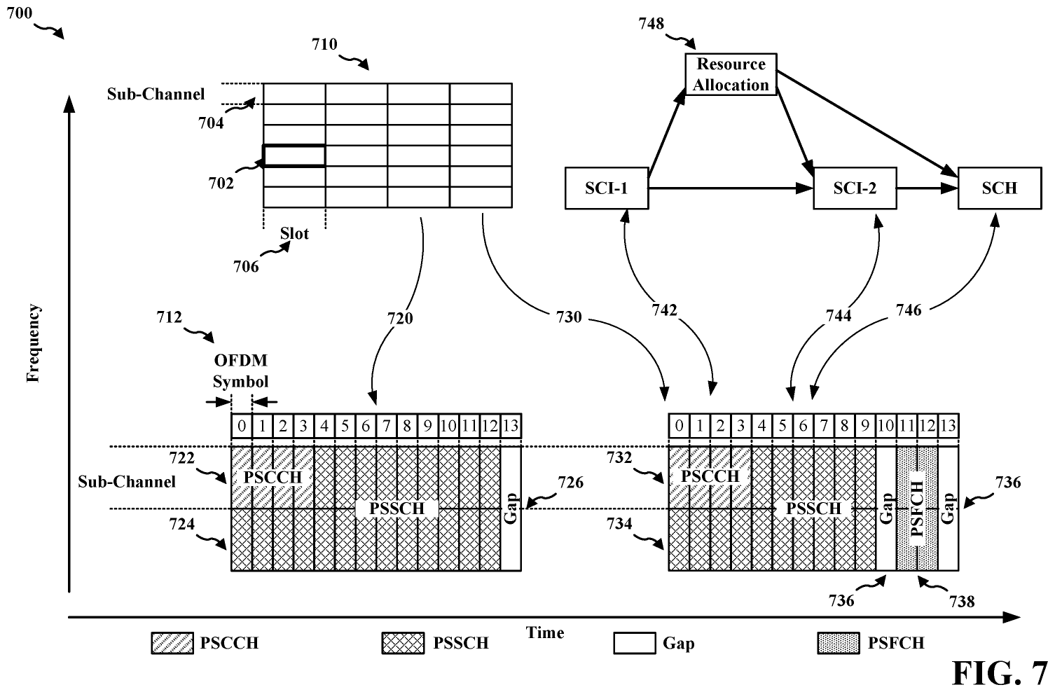

FIG. 7 is a diagram 700 illustrating a set of time-and-frequency resources 710 for sidelink (SL) communication. In some aspects, the set of time-and-frequency resources 710 for SL communication are divided into reservable/allocable time-and-frequency resource units, e.g., time-and-frequency resource unit 702. The time-and-frequency resource unit 702, in some aspects, span one sub-channel 704 in frequency and span one slot 706 in time. The sub-channels 704 may by (pre)configured to include one of 10, 15, 20, 25, 50, 75, or 100 PRBs. Some slots may not be available/allocable for SL. The set of time-and-frequency resources 710 may be pre-configured (e.g., pre-loaded on a UE) or may be configured by a base station (e.g., via an RRC message).

In some aspects, a slot may include 14 OFDM symbols (e.g., OFDM symbol 712), while fewer than 14 symbols may be (pre)configured for SL data. A first symbol (e.g., symbol “0”) may be repeated in a preceding symbol for automatic gain control (AGC) settling. An SL-allocable slot 720 may include a first set of symbols in a first set of sub-channels including PSCCH 722, a second set of symbols in a second set of sub-channels including PSSCH 724, and a gap symbol 726 that may follow the PSSCH symbols 724. An SL-allocable slot 730 may include a first set of symbols in a first set of sub-channels including PSCCH 732, a second set of symbols in a second set of sub-channels including PSSCH 734, a first gap symbol 736 that may follow the PSSCH symbols 734, a third set of symbols in a third set of sub-channels including PSFCH 738, and a second gap symbol 736 that may follow the PSFCH 738. The third set of symbols in the third set of sub-channels including PSFCH 738 may include a first symbol of PSFCH and a second symbol that is a repetition of the first PSFCH symbol for AGC settling. In some aspects, PSCCH and PSSCH may be transmitted in a same slot. In some aspects, slots including PSFCH may be configured with a period of 0, 1, 2, or 4 slots.

SL control information (SCI) may include a first stage of control information (e.g., SCI-1 742) that is transmitted via PSCCH and may contain information for resource allocation (e.g., resource allocation 748) and for decoding second stage control information (e.g., SCI-2 744). Second stage control information (e.g., SCI-2 744) may be transmitted via PSSCH and may contain information for decoding data in a shared channel (e.g., SCH 746). In some aspects SCI-1 may be decodable for UEs in multiple releases, while new SCI-2 formats may be introduced in future releases. Both SCI-1 and SCI-2, in some aspects, may be transmitted via a PDCCH polar code.

As discussed in relation to FIGS. 4-7 different devices may support different architectures, time-and-frequency resources, or different waveforms. Specifically, in a mixed network as described in relation to FIG. 6, different devices may differently support RF ET/EH. In such cases, it may be beneficial to introduce methods for identifying common characteristics (or negotiating time-and-frequency resources and waveforms) for an EH operation between different EH/ET-capable devices.

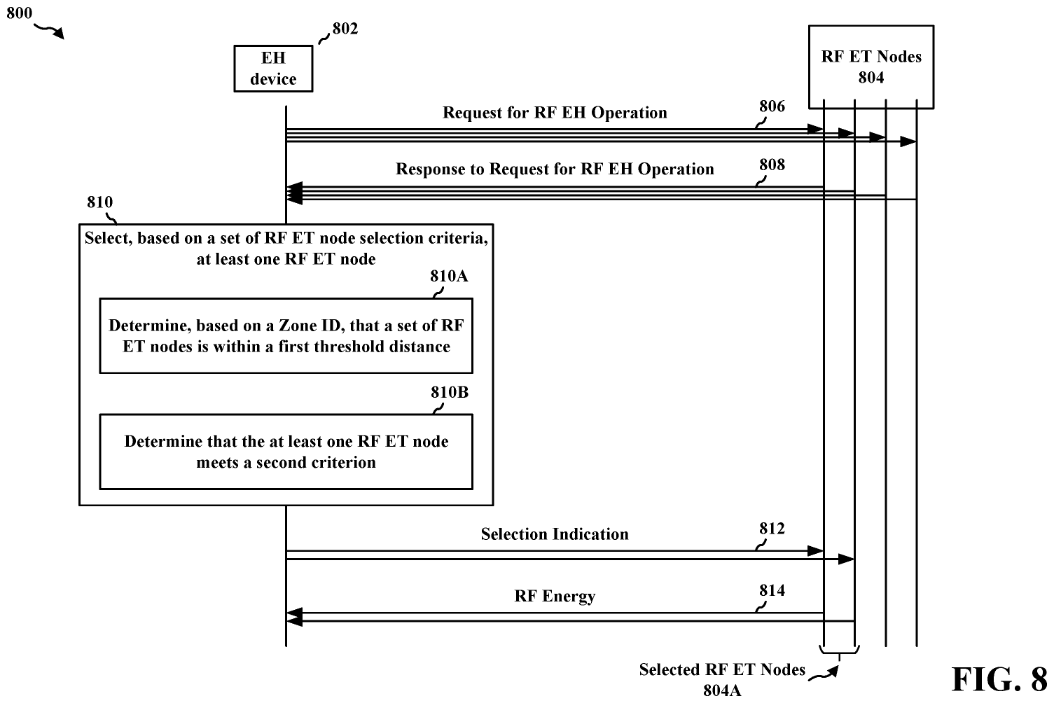

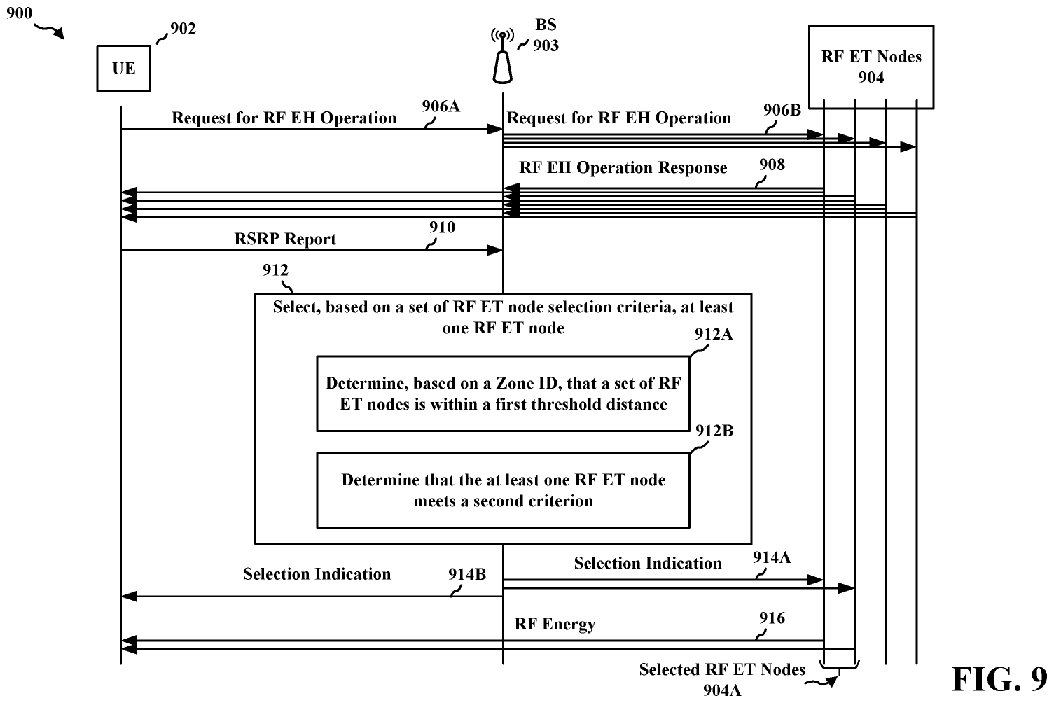

FIG. 8 is a call flow diagram 800 illustrating a EH device 802 (e.g., an EH-capable device) in communication with a set of RF ET nodes 804 (e.g., a set of ET-capable devices) negotiating (initiating) an EH operation. An example EH device may include a UE, a wearable, a sensor, an IoT device, and XR device, etc. An ET capable device may include a UE, a customer premise equipment (CPE), a pico cell, a micro cell, a small cell, a base station, an IAB node, etc.) FIG. 9 is a call flow diagram 900 illustrating a EH device 902 (e.g., an EH-capable UE) negotiating an EH operation with a set of RF ET nodes 904 (e.g., a set of ET-capable devices or base stations) via a base station 903. Similar elements in call flow diagrams 800 and 900 will be described together below along with a description of the different elements. The EH device 802/902 may transmit a request (or set of requests) 806/906A for an RF energy harvesting operation. The request for RF energy harvesting operation 806/906A may include an indication of an EH architecture at the EH device 802/902, e.g., that the EH architecture of the EH-capable UE is capable of supporting one of (i) separated-receiver-based EH, (ii) time-switching-based EH, or (iii) power-splitting-based EH. In some aspects, the request 806 may indicate a duration of an EH session requested by the EH-capable UE and/or a set of waveforms supported for ET at the RF ET node. In some aspects, the request may be referred to as an EH solicitation message.

As indicated in diagram 800, the RF ET nodes (e.g., UEs, CPEs, base stations, etc.) in the set of RF ET nodes 804 may receive the request 806. As indicated in diagram 900, the base station 903 may receive the request 906A and may (re)transmit the request 906A to the set of RF ET nodes 904 as request 906B based on the content of the request 906A. Based on the request 806/906B, the RF ET nodes in the set of RF ET nodes 804/904 may each transmit a response 808/908. The request, e.g., solicitation message, may indicate a QoS related top EH, e.g., a type of EH service, a time to use the EH service, etc. The response 808 may correspond to a QoS response that includes information about the QoS parameters indicated by the EH device 802. The response 808/908 from a particular RF ET may include information regarding a type of RF ET that the ET node supports, e.g., whether the particular RF ET node supports at least one of (i) separated-receiver-based EH (or ET), (ii) time-switching-based EH (or ET), or (iii) power-splitting-based EH (or ET). The response 808/908 may indicate information about how fast the candidate ET device can provide energy, e.g., a duration of an EH session supported by the particular RF ET node and/or a periodicity and interval for ET from the particular RF ET node. The response 808/908 may indicate a set of waveforms supported for ET at the particular RF ET node. For example, an RF ET node may be capable of adjusting a modulation and coding scheme (MCS) based on power-splitting-based ET/EH. The information regarding the periodicity and interval for ET from the particular RF ET node may identify specific time-and-frequency resources for ET and a periodicity associated with the repetition time-and-frequency resources. Among other examples, the information regarding the set of waveforms supported for ET at the particular RF ET node may indicate whether the RF ET node is capable of supporting any or all of (1) a deterministic signal, (2) a circularly symmetric complex gaussian random signal, (3) an improper complex gaussian random signal (e.g., a signal with real and imaginary parts that have different variances), or any other type of signal for ET/EH. In some aspects, the response may indicate that the ET node is at least temporarily unavailable for ET. In some aspects, the response may indicate a time period, e.g., a time period after which the EH device may check with the ET node for EH support.

Based on the responses 808/908 from the set of RF ET nodes 804/904, the EH device 802 (or the base station 903) may select 810/912, based on a set of RF ET node selection criteria, at least one RF ET node (e.g., selected RF ET nodes 804A/904A) in the set of RF ET nodes 804/904. The selection criteria may include criteria relating to a combination of one or more of (1) RF ET node characteristics, (2) RF ET node connection quality characteristics, (3) distance characteristics, or (4) mobility characteristics. The RF ET node characteristics criteria may include criteria related to one or more of (1) whether the at least one RF ET supports at least one of (i) separated-receiver-based EH, (ii) time-switching-based EH, or (iii) power-splitting-based EH that is also supported by the EH-capable UE, (2) a duration of an EH session supported by the at least one RF ET node, (3) a periodicity and interval for ET, or (4) a set of waveforms supported for ET at the RF ET node. In some aspects the selection criteria may include one or more criteria that is defined, e.g., in a wireless standard.

In some aspects, the criteria related to connection quality characteristics may include one or more criteria related to at least one of (1) a channel power threshold for ET, (2) whether the at least one RF ET node is already communicating with the EH-capable UE, or (3) the type of communication between the at least one RF ET node and the EH-capable UE. For example, the EH device 902 may transmit, and base station 903 may receive, a reference signal received power (RSRP) report 910. The RSRP report 910 may be based on an RSRP measurement performed by the EH device 902 for each of a set of transmissions from the set of RF ET nodes 904. The RSRP report 910 may include information regarding, an RSRP measured at the EH device 902 associated with different transmissions from the set of RF ET nodes 904 to the EH device 902, e.g., different transmissions from different RF ET nodes in the set of RF ET nodes 904 and/or different transmissions using different waveforms or beam directions, to determine if the measured RSRP is above a threshold for ET. The RSRP threshold for ET may be different from a RSRP threshold for SL communication and/or a threshold for SL communication may be based on a different measured characteristic (e.g., reference signal received quality (RSRQ), signal-to-noise ratio (SNR), etc.). In some aspects, the EH device 802 or the base station 903 may select an RF ET node based on the RF ET node being in communication with the EH device 802/902 and having previously performed a connection process (e.g., beam sweeping, beam refinement, etc.). The criteria related to the type of communication may include a traffic density threshold of the communication between the RF ET node and the EH-capable evice (e.g., EH device 802/902) such that a connected RF ET node is not selected for a communication session in the presence of a threshold traffic density (e.g., more than 70%, 80%, or 90% of available slots containing data). The criteria related to the type of communication may also include whether the connection employs specific formats (e.g., URLLC or eMBB) may be considered independently and/or may be associated with different traffic density thresholds.

The criteria related to distance characteristics, in some aspects, may include a threshold distance from the at least one RF ET node estimated via one or more of (i) at least one positioning procedure, (ii) known positions of the EH-capable UE and the at least one RF ET, (iii) at least one zone ID, or (iv) a location management function. The threshold distance may be different for different types of RF ET nodes based on an advertised transmission power capability. For example, a small cell base station, a mobile device, a laptop, or a wearable device may each be capable of different transmission powers that are each associated with different threshold distances. The distance between the target EH-capable device (e.g., EH device 802/902) and a particular RF ET node in a set of candidate RF ET nodes 804/904 (e.g., the set of RF ET nodes 804/904) may be estimated based on a calculated or known position of the two devices based on a positioning procedure. For example, a position of the devices may be determined based on multi-/single-cell and device-based positioning, a positioning reference signal (PRS) used by various 5G positioning techniques such as roundtrip time (RTT), angle of arrival/departure (AoA/AoD), and time difference of arrival (TDOA). In some aspects, a location management function (e.g., a location server) may be used to determine the distance.

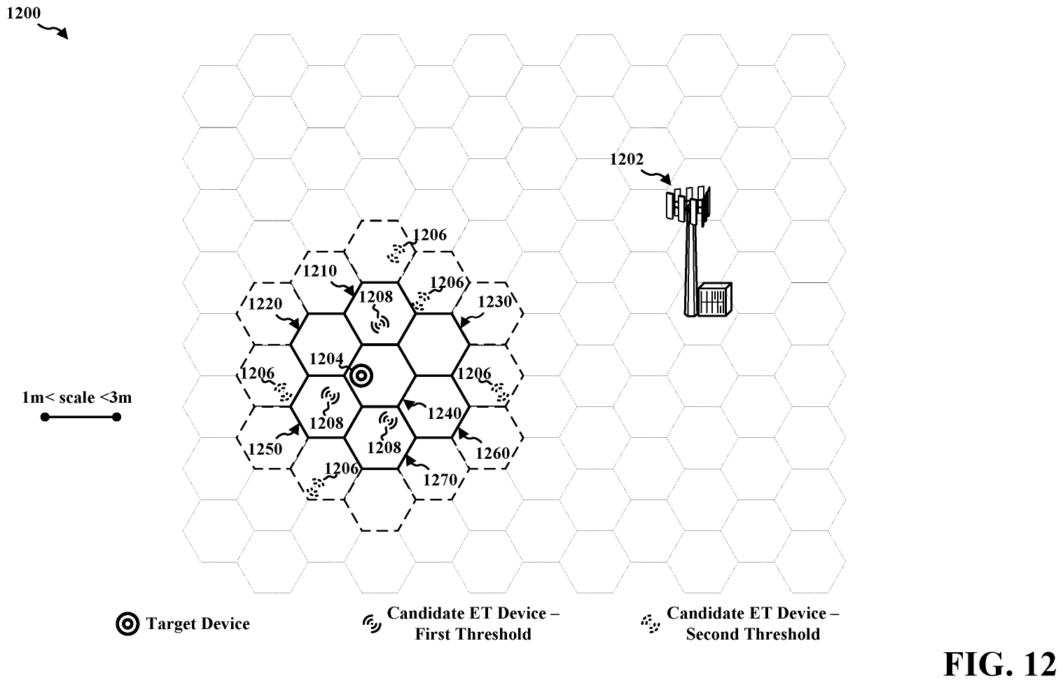

In some aspects, a zone ID associated with the source (e.g., an RF ET node in the set of RF ET nodes 804/904) and target (e.g., EH-capable EH device 802/902) devices may be used, in some aspects, to estimate a distance. The response 808/908 or other communication from an ET node may indicate a zone ID. The zone ID may be a newly-defined zone ID identifying spatial areas defined for EH operations such that the zone IDs can be used to independently estimate a distance without additional information (e.g., as will be discussed in relation to FIG. 12). Alternatively, a zone ID for other purposes, such as a sidelink zone ID, or other zone ID may be used as a first pass filter to determine 810A/912A that a first set of RF ET nodes is within a first threshold distance of the EH-capable UE (e.g., within one or two zones of the EH-capable UE) while a second distance determination procedure as discussed above may be employed to determine 810B/912B whether RF ET nodes that are determined to be within the first threshold distance are within a second, smaller threshold distance (e.g., meets a second distance-based criterion). The second determination, in some aspects, may relate to a received power measurement employed to determine 810B/912B whether a transmission from an RF ET node that is determined to be within the first threshold distance is received with a power that is above a power (e.g., RSRP) threshold (e.g., meets a second power-based criterion). The two step distance-based or distance-and-power-based selection reduce the number of distance determinations (or power measurements) that are made to select the RF ET nodes for the EH operation.

The criteria related to mobility characteristics, in some aspects, include one or more criteria related to at least one of (1) a mobility of the at least one RF ET node, (2) a mobility of the EH-capable UE, or (3) a relative mobility of the at least one RF ET node and the EH-capable UE. For example, a UE may use information regarding the mobility of an RF ET node and its own mobility to determine that distance is increasing between the two devices at a rate that is above a threshold rate and that the RF ET node is not a preferred RF ET node for an EH operation. The threshold rate, in some aspects, may be based on a current distance between the UE and the RF ET node (e.g., the threshold rate may be a rate at which the devices are predicted to be within a configured threshold distance for at least a configured interval). The UE and RF ET node may both be moving, but as long as the EH-capable UE and the RF ET node are not moving relative to each other the RF ET node may be a preferred partner for the EH operation. For example, if the UE and the RF ET node are located in a same car or are associated with a same person (e.g., a phone and a watch carried by the same person) the relative mobility may be below a threshold for excluding an RF ET node.

The EH device 802, or the base station 903, may transmit, based on the selection 810/912, a selection indication 812/914A to a set of selected RF ET nodes 804A/904A in the set of RF ET nodes 804/904. In some aspects a base station 903 may also transmit, and EH device 902 may receive, an indication to receive the RF energy from the set of selected RF ET nodes 904A. The selection indication 812 may indicate to the selected RF ET node to transmit the RF energy to the EH-capable UE (e.g., that the RF ET node has been selected for an EH operation with the EH device 802/902). The selection indication 812/914A/914B may further indicate a set of resources and/or waveforms for the EH operation. If no previous connection existed between a selected RF ET node 804A/904A and the EH device 802/902, the selection indication 812/914A/914B may further initiate a connection operation (e.g., beam sweeping, beam refining, power management, etc.).

Based on the selection indication 812/914A/914B, the selected RF ET nodes 804A/904A may then transmit RF energy 814/916. The RF energy 814/916 may be transmitted based on the request for RF EH operation 806/906A/906B and the response 808/908. For example, the RF energy 814 may be transmitted via resources identified in the request 806 and the response 808. The RF energy 814/916 may be transmitted via a waveform indicated to be supported by both the EH-capable EH device 802/902 and the RF ET node 804/904 in the request 806/906A and response 808/908.

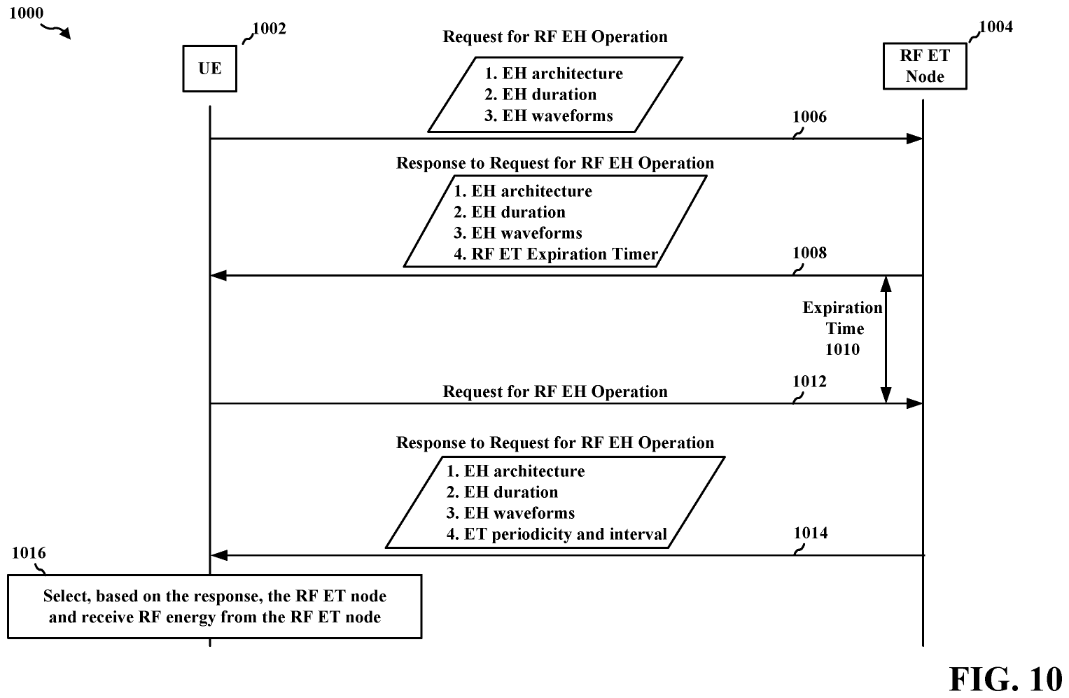

FIG. 10 is a call flow diagram 1000 illustrating a EH device 1002 (e.g., an EH-capable UE) in communication with a particular RF ET node 1004 (e.g., an ET-capable device or base station). Diagram 1000 illustrates a request for an RF ET operation 1006 that may include the same indications as request 806 of FIG. 8. The RF ET node 1004 may transmit a response 1008 that includes similar indications to the response 808 of FIG. 8, but instead of, or in addition to, the ET periodicity and interval information, the response 1008 may include an RF ET request expiration timer that indicates that the RF ET node 1004 is not currently available for ET and a time at which a new request can be made.

The EH device 1002 may receive the response 1008 from the RF ET node 1004 as well as additional responses from other RF ET nodes as described in relation to FIG. 8. The EH device 1002 may select an RF ET node as described in relation to the selection 810 of FIG. 8 based on the additional responses from other RF ET nodes. After the passage of the expiration time 1010, the EH device 1002 may transmit an additional request 1012 for an EH operation. The RF ET node 1004 may receive the request 1012 and transmit, based on the request 1012, a second response 1014 indicating the characteristics of the RF ET node 1004 and the availability of the RF ET node 1004. The EH device 1002 may receive the response 1014 and, based on the response 1014, the EH device 1002 may select 1016 the RF ET node 1004 and receive RF energy from RF ET node 1004 as described in relation to 810-814 of FIG. 8. Although the description above relates to a system similar to the system illustrated in FIG. 8, similar expiration timer information may be indicated to a base station by an RF ET node in a system similar to the system illustrated in FIG. 9.

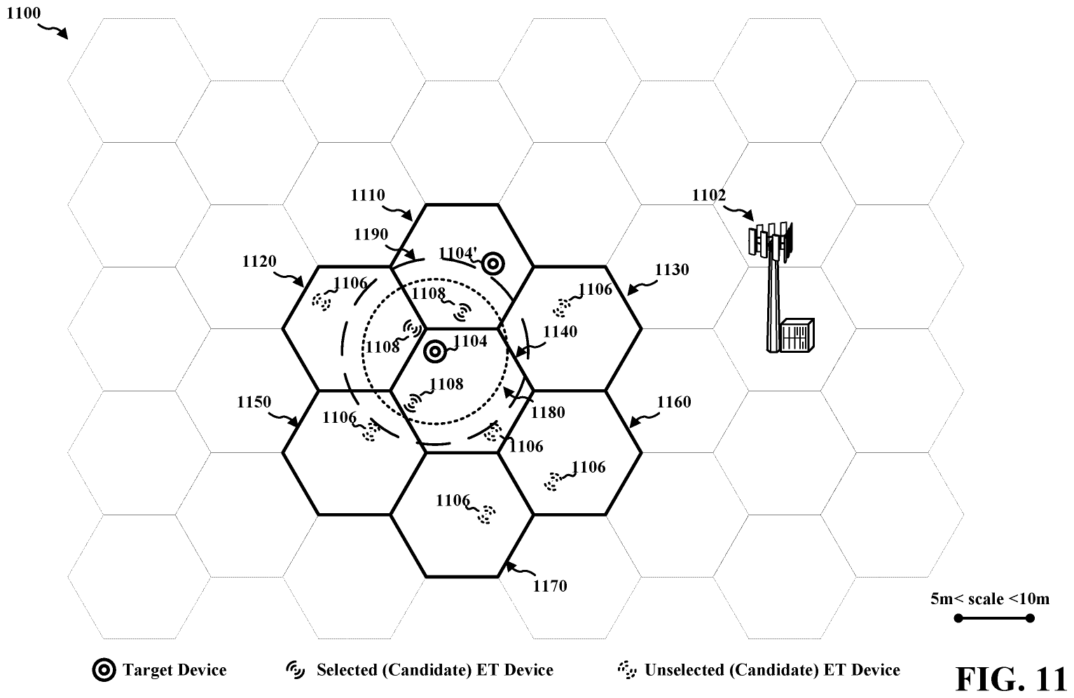

FIG. 11 is a diagram 1100 illustrating an example first zone ID-based threshold and a second distance-based threshold. Diagram 1100 includes a base station 1102, a first target device (e.g., a UE, a wearable device, an IoT device, etc.) 1104 (e.g., EH device 802/902), and a second target device 1104′. Diagram 1100 also includes a set of RF ET devices 1106 and 1108 (e.g., the set of RF ET nodes 804/904) that can participate in an EH operation. Diagram 1100 illustrates a set of hexagonal zones each associated with a zone ID (e.g., a 12-bit identifier). The first target device 1104 is in a first zone 1140 in a set of zones each covering an area of approximately 10-100 square meters. The first zone 1140 and a set of adjacent zones 1110-1130 and 1150-1170 are identified as zones associated with a first threshold distance as described in relation to selection operations 810A and 912A of FIGS. 8 and 9. Accordingly, the RF ET devices 1106 and 1108 are identified (by the UE 1104 or base station 1102) as a first set of candidate RF ET devices.

After identifying the first set of candidate RF ET devices, the first target device 1104 (or the base station 1102) may perform a second selection operation (e.g., operation 810B/912B of FIGS. 8 and 9) to determine a second set of RF ET nodes 1108 that are each within a distance threshold 1180 from the first target device 1104. As described, above in relation to FIGS. 8 and 9, different distance thresholds, e.g., distance thresholds 1180 and 1190, for different types of devices (e.g., devices with different transmission power characteristics) may be applied by the first target device 1104 (e.g., as described in relation to the EH device 802 of FIG. 8) or the base station 1102 (e.g., as described in relation to the base station 903 of FIG. 9). In some aspects, a particular RF ET device 1108 (e.g., RF ET device 1108 in the zone 1110) may be selected to provide RF energy to more than one target device (e.g., to both the first target device 1104 and the second target device 1104′).

FIG. 12 is a diagram 1200 illustrating a zone ID-based distance determination. Diagram 1200 includes a base station 1202 and a first target device (e.g., a UE, a wearable device, an IoT device, etc.) 1204 (e.g., EH device 802/902). Diagram 1200 also includes a set of RF ET devices 1206 and 1208 (e.g., the set of RF ET nodes 804/904) that can participate in an EH operation. Diagram 1200 illustrates a set of hexagonal zones each associated with a newly-defined zone ID (e.g., a zone ID that applies to a different size zone (e.g., 1-10 square meters) or a new zone ID format that is specified by an identifier using a different number of bits).

The first target device 1204 is in a first zone 1240 in a set of zones each covering an area of approximately one to ten square meters. The first zone 1240 and a set of adjacent zones 1210-1230 and 1250-1270 indicated with solid boundaries are identified as zones associated with a first zone-based threshold (e.g., within one zone). RF ET devices 1208 may be identified as candidate RF ET devices for an EH operation by the target device 1204 or by the base station 1202 based on the first zone-based threshold. In some aspects, a zone-based threshold may identify zones within two zones (zones indicated by dashed line boundaries) as being associated with the zone-based threshold. RF ET devices 1208 and 1206 may be identified as candidate RF ET devices for an EH operation by the target device 1204 or by the base station 1202 based on the second zone-based threshold. In some aspects, the RF ET devices 1208 may be preferred (e.g., using a weighting or other value) over the RF ET devices 1206 based on their proximity. In some aspects, the (newly-defined) zone ID associated with the at least one RF ET node, in addition to a (newly-defined) zone ID associated with the EH-capable UE, is sufficient to determine that the RF ET node is within a threshold distance from the EH-capable UE.

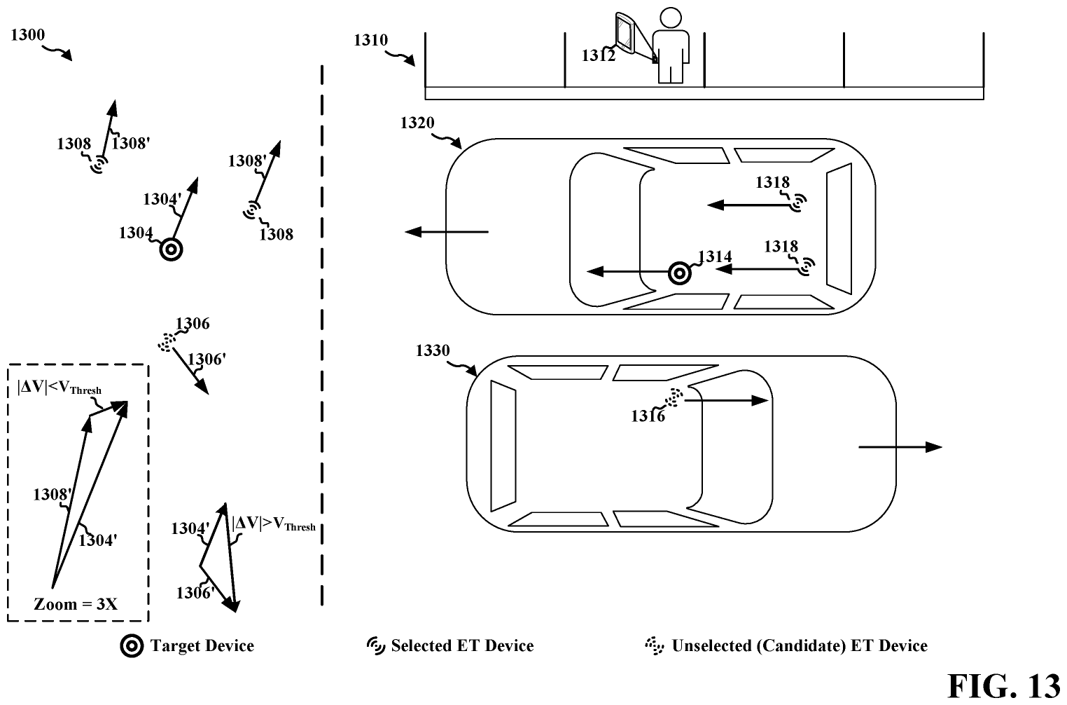

FIG. 13 is a set of diagram 1300 and 1310 illustrating a selection of a set of RF ET nodes 1308 for an EH-target device 1304. Diagram 1300 illustrates a first device (e.g., target device 1304) associated with a first mobility (velocity vector 1304′), second and third (selected) RF ET devices 1308 associated with second and third mobilities (e.g., velocity vectors 1308′), and a fourth RF ET device 1306 associated with a fourth mobility (e.g., velocity vector 1306′). Diagram 1300 further illustrates velocity differences (ΔV) between a vector 1304′ and each of velocity vectors 1306′ and 1308′ with magnitudes that are above and below a relative velocity (mobility) threshold, V_{Thresh}, respectively. The RF ET devices 1308 may be selected for an EH operation with target device 1304 (e.g., by target device 1304 or by a base station) based on a determination that the mobility of the target device 1304 and of the RF ET devices 1308 is within a threshold mobility difference (e.g., 0.1-0.5 meters/second). In some aspects, the threshold mobility difference (e.g., a relative mobility threshold) may be based on one or more of (1) the expected duration (or a minimum duration) of the energy harvesting operation, (2) an initial distance between the target device 1304 and the RF ET device 1308, or (3) a maximum (e.g., threshold) acceptable distance between the target device 1304 and the RF ET device 1308. For example, a target device 1304 may determine a relative mobility threshold (MT) of 2 meters per second (m/s) for a particular RF ET device 1308 based on a current distance (d) from the RF ET device 1308 of 1 meter, a maximum acceptable distance (dₘₐₓ) of 3 meters and an expected, or minimum, duration (t) of the EH operation of 1 second (e.g., using an equation MT=(dₘₐₓ−d)/t).

As described in relation to diagram 1300, the relative mobility (e.g., relative velocity or ΔV) may be considered instead of an absolute mobility measurement. Diagram 1310 illustrates an example in which a low mobility may be associated with a UE 1312 (e.g., standing or walking) and a high mobility (e.g., moving in a vehicle 1320 or 1330 at high speed) may be associated with each of the devices 1314-1318. The selected devices, in such a situation may be devices with high mobility (e.g., RF ET devices 1318 in a same vehicle 1320 with a target device 1314) based on the low relative mobility while the device 1312 with low mobility and RF ET device 1316 with high mobility in a different direction are not selected based on a high relative mobility (e.g., a relative mobility above a threshold). Similar situations may apply to a target wearable device and an RF ET device associated with a same person (e.g., a watch on a person's wrist and a mobile phone in the person's pocket).

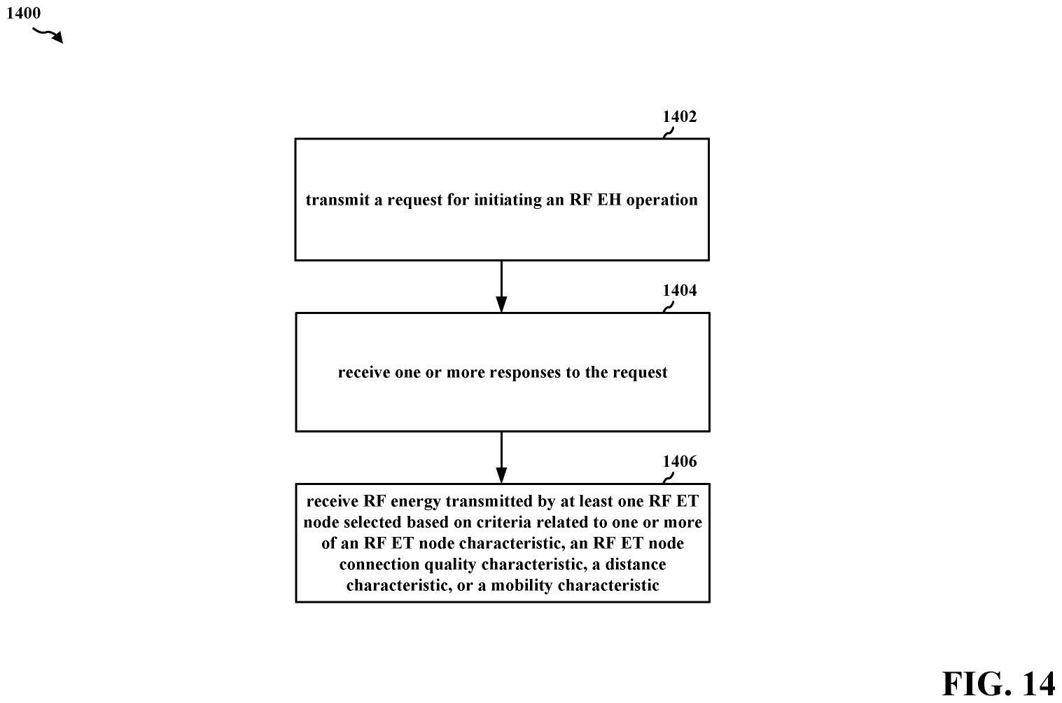

FIG. 14 is a flowchart 1400 of a method of wireless communication. The method may be performed by an EH device (e.g., the UE 104/610; the EH device 802/902/1002; the target device 1104/1204/1304; the apparatus 2102). At 1402, the UE (or target device) may transmit a request for initiating an RF EH operation. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 8-10, the EH device 802/902/1002 may transmit a request 806/906A/1006 to a set of RF ET nodes 804, a base station 903, or an RF ET node 1004. For example, 1402 may be performed by an RF EH request component 2140.

At 1404, the target device may receive one or more responses to the request. The response, received at 1404, may include an indication of support for one or more of (1) the separated-receiver-based EH indicated in the request, (2) the time-switching-based EH indicated in the request, (3) the power-splitting-based EH indicated in the request, (4) an EH session of the duration indicated in the request, (5) at least one waveform in the set of one or more waveforms indicated in the request, or (6) support for a periodicity and interval for ET. In some aspects, the response, at 1404, may also, or alternatively, include an indication that a particular RF ET node is not available and an indication of a time after which an additional request may be transmitted by the EH-capable UE. For example, referring to FIGS. 8-10, the EH device 802/902/1002 may receive a response 808/908/1008 from a set of RF ET nodes 804/904 or an RF ET node 1004. For example, 1404 may be performed by an RF EH request component 2140.

Finally, at 1406, the UE (or target device) may receive RF energy transmitted by at least one RF ET node selected based on criteria related to one or more of an RF ET node characteristic, an RF ET node connection quality characteristic, a distance characteristic, or a mobility characteristic. For example, referring to FIGS. 8-13, based on a selection of at least one RF ET node (as described below, the EH device 802/902/1002/1104/1204/1304/1314 may receive RF energy from a set of ET devices (nodes) 804A/904A/1004/1108/1206/1208/1308. The RF ET node characteristic criteria may include (e.g., the selection may be based on) at least one of (1) support of separated-receiver-based EH, (2) support of time-switching-based EH, (3) support of power-splitting-based EH, (4) support for a duration of an EH session, (5) support for a periodicity and interval for ET, or (6) a waveform supported for ET.

In some aspects, the criteria related to connection quality characteristics may include (e.g., the selection may be based on) one or more criteria related to at least one of (1) a channel power threshold for ET, (2) an established connection with the EH-capable UE, or (3) a type of communication between the at least one RF ET node and the EH-capable UE. For example, the UE (or target device) may measure an RSRP associated with a transmission from an RF ET node to the UE (or target device) to determine if the measured RSRP is above a threshold for ET. The RSRP threshold for ET may be different from a RSRP threshold for SL communication and/or a threshold for SL communication may be based on a different measured characteristic (e.g., RSRQ, SNR, etc.). In some aspects, the UE (or target device) may select an RF ET node based on the RF ET node being in communication with the UE (or target device) and having previously performed a connection process (e.g., beam sweeping, beam refinement, etc.). The criteria related to the type of communication may include a traffic density threshold of the communication between the RF ET node and the EH-capable UE such that a connected RF ET node is not selected for a communication session in the presence of a threshold traffic density (e.g., more than 70%, 80%, or 90% of available slots containing data). The criteria related to the type of communication may also include whether the connection employs specific formats (e.g., URLLC or eMBB). The communication format may be considered independently and/or may be associated with different traffic density thresholds (e.g., a first traffic density threshold associated with URLLC and a second, higher or lower, traffic density threshold associated with eMBB).

The criteria related to distance characteristics, in some aspects, may include a threshold distance between the EH-capable UE and the at least one RF ET node. In some aspects, the distance (or a distance determination) is based on one or more of (1) a positioning procedure, (2) measurement of a reference signal from the RF ET node, (3) known positions of the UE (or target device) and the RF ET node, (4) at least one zone ID indicated in SL control information, or (5) a location management function. The threshold distance may be different for different types of RF ET nodes based on an advertised transmission power capability. For example, a small cell base station, a mobile device, a laptop, or a wearable device may each be capable of different transmission powers that are each associated with different threshold distances. Additionally, each device may be associated with (e.g., may advertise) a different transmission power capability based on a state of the device (e.g., plugged in to a power source, high battery power, low battery power, etc.).

For example, referring to FIGS. 8-12, the distance between the EH device 802/902/1002 (or target device 1104/1204) and a particular RF ET node (e.g., RF ET node 1004) in a set of candidate RF ET nodes 804/904/1106/1108/1206/1208 may be estimated based on a calculated or known position of the two devices based on a positioning procedure. For example, a position of the devices may be determined based on multi-/single-cell and device-based positioning, a positioning reference signal (PRS) used by various 5G positioning techniques such as roundtrip time (RTT), angle of arrival/departure (AoA/AoD), and time difference of arrival (TDOA). In some aspects, a location management function (e.g., a location server) may be used to determine the distance.

Referring to FIGS. 8-12, a zone ID associated with the RF source, e.g., ET device 1106/1108/1206/1208 and the UE (or target device), e.g., target device 1104/1204 (corresponding to EH-capable EH device 802/902/1002), may be used, in some aspects, to estimate a distance. The zone ID may be a newly-defined zone ID (as described in relation to FIG. 12) identifying spatial areas defined for EH operations such that the zone IDs can be used to independently estimate a distance without additional information. Alternatively, a zone ID (either a legacy zone ID or a newly-defined zone ID) may be used as a first pass filter to determine that a first set of RF ET nodes 1106 and 1108 (or 1206 and 1208) is within a first threshold distance of the target device 1104/1204 (corresponding to EH device 802/902/1002). For example, for a threshold distance of one zone (e.g., including adjacent zones), the set of ET devices 1106/1108/1208 may be determined to be within one zone of the target device 1104/1204, while for a threshold distance of two zones, the set of ET devices 1206/1208 may be determined to be within two zones of the target device 1204 (as described in relation to 810A/912A).

A second distance determination procedure as discussed above may be employed to determine whether RF ET devices 1106/1108/1206/1208 that are determined to be within the first threshold distance are within a second, smaller threshold distance 1180 or 1190 (e.g., meets a second distance-based criterion). The second determination, in some aspects, may relate to a received power measurement employed to determine 810B/912B whether a transmission from an RF ET node that is determined to be within the first threshold distance is received with a power that is above a power (e.g., RSRP) threshold (e.g., meets a second power-based criterion). The two step distance-based or distance-and-power-based selection reduce the number of distance determinations (or power measurements) that are made to select the RF ET devices for the EH operation.

In some aspects, the criteria related to mobility characteristics may include (e.g., the selection may be based on) one or more criteria related to at least one of (1) a mobility state of the at least one RF ET node, (2) a mobility state of the EH-capable UE, or (3) a relative mobility state of the at least one RF ET node and the EH-capable UE. For example, referring to FIGS. 8, 9, and 13, a EH device 802/902/1304/1314 may use information regarding the mobility of an RF ET node 1306/1308/1312/1316/1318 and its own mobility to determine that the two devices are moving away from each other at a rate that is, or is not, below a threshold rate (V_{Thresh}) and that the RF ET node is, or is not, a preferred RF ET node for an EH operation. The determination may be performed as part of a selection as described in relation to selection 810/912. For example, the selection of the at least one RF ET node at 1406 may be performed by RF EH peer selection component 2142, while receiving the RF energy from the at least one RF ET node may be performed by RF EH component 2144.

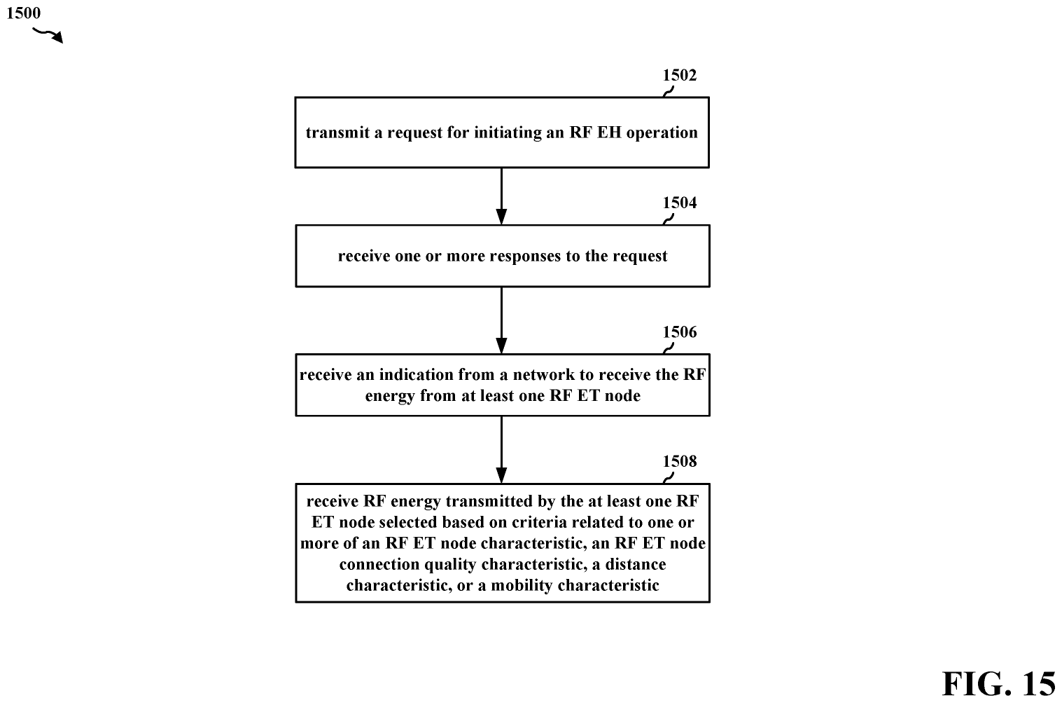

FIG. 15 is a flowchart 1500 of a method of wireless communication. The method may be performed by a device (e.g., the UE 104/610/802/902/1002; the target device 1104/1204/1304; the apparatus 2102). At 1502, the UE (or target device) may transmit a request for initiating an RF EH operation. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 8-10, the EH device 802/902/1002 may transmit a request 806/906A/1006 to a set of RF ET nodes 804, a base station 903, or an RF ET node 1004. For example, 1502 may be performed by an RF EH request component 2140.

At 1504, the UE (or target device) may receive one or more responses to the request. The response, received at 1504, may include an indication of support for one or more of (1) the separated-receiver-based EH indicated in the request, (2) the time-switching-based EH indicated in the request, (3) the power-splitting-based EH indicated in the request, (4) an EH session of the duration indicated in the request, (5) at least one waveform in the set of one or more waveforms indicated in the request, or (6) support for a periodicity and interval for ET. In some aspects, the response, at 1504, may also, or alternatively, include an indication that a particular RF ET node is not available and an indication of a time after which an additional request may be transmitted by the EH-capable UE. For example, referring to FIGS. 8-10, the EH device 802/902/1002 may receive a response 808/908/1008 from a set of RF ET nodes 804/904 or an RF ET node 1004. For example, 1504 may be performed by an RF EH request component 2140.

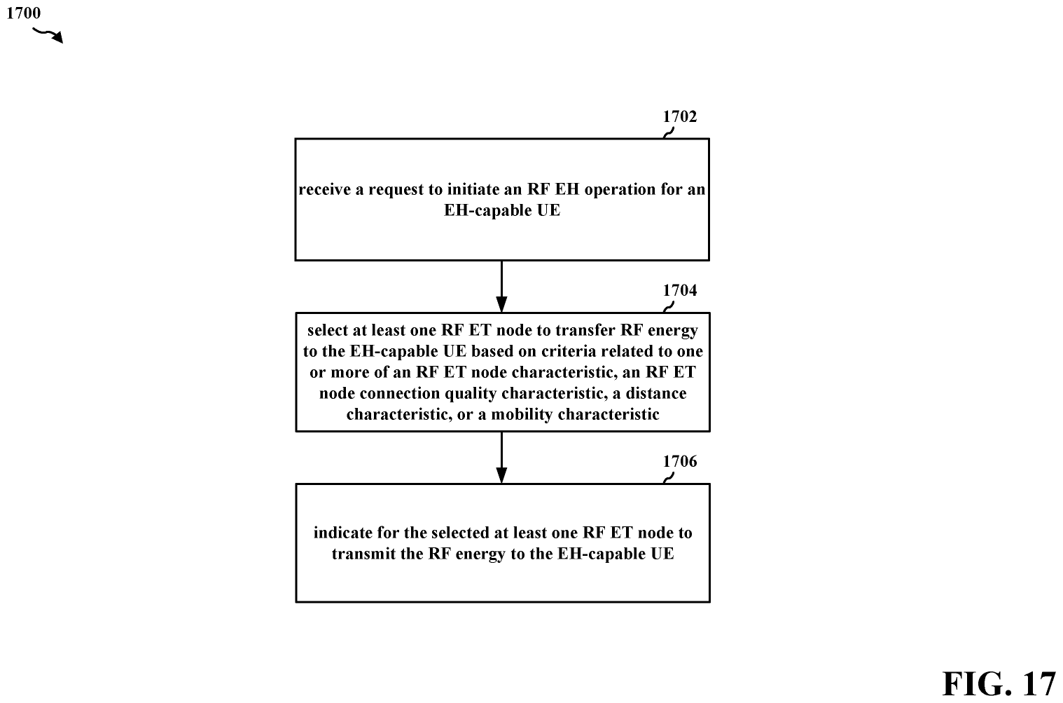

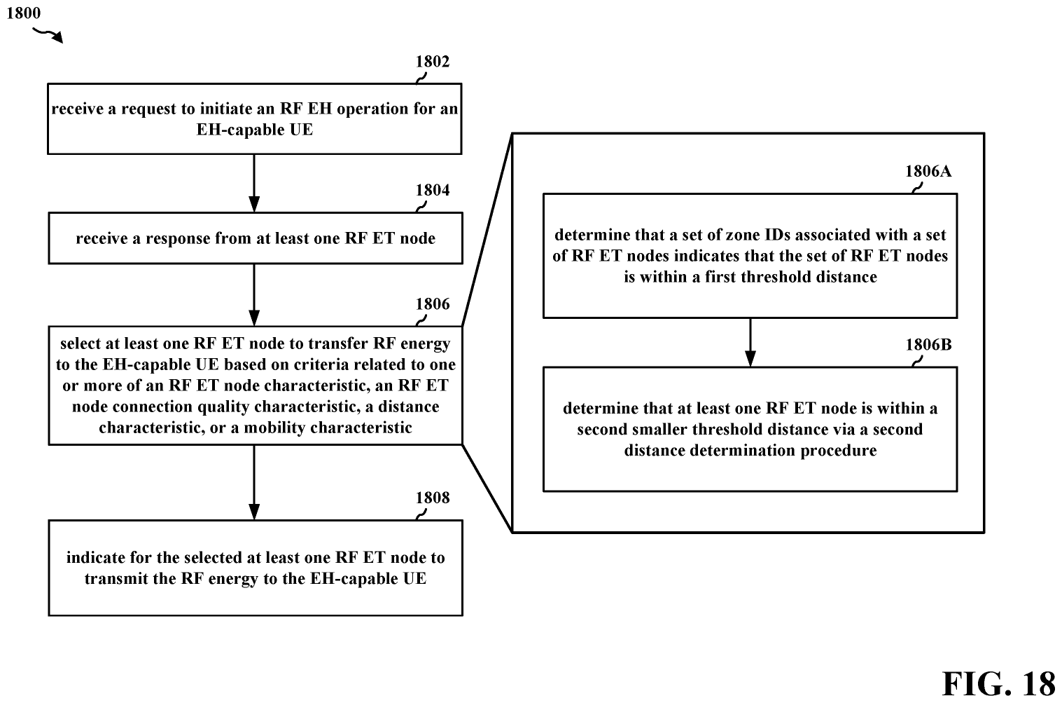

At 1506, the UE (or target device) may receive an indication from a network to receive the RF energy from at least one RF ET node. For example, referring to FIG. 9, the EH device 902 may receive selection indication 914B from base station 903. The base station 903 may select the indicated at least one RF ET node as described above in relation to selection 912 and as will be described below in relation to FIGS. 17 and 18. For example, 1506 may be performed by RF EH peer selection component 2142.

Finally, at 1508, the UE (or target device) may receive, based on the received indication at 1506, RF energy transmitted by the at least one RF ET node indicated from the network (e.g., base station). The at least one RF ET node having been selected based on criteria related to one or more of an RF ET node characteristic, an RF ET node connection quality characteristic, a distance characteristic, or a mobility characteristic. For example, referring to FIG. 9, the EH device 902 may receive selection indication 914 Buse information regarding the mobility of an RF ET node 1306/1308/1312/1316/1318 and its own mobility to determine that the two devices are moving away from each other at a rate that is, or is not, below a threshold rate (V_{Thresh}) and that the RF ET node is, or is not, a preferred RF ET node for an EH operation. The determination may be performed as part of a selection as described in relation to selection 810/912. For example, 1508 may be performed by RF EH component 2144.

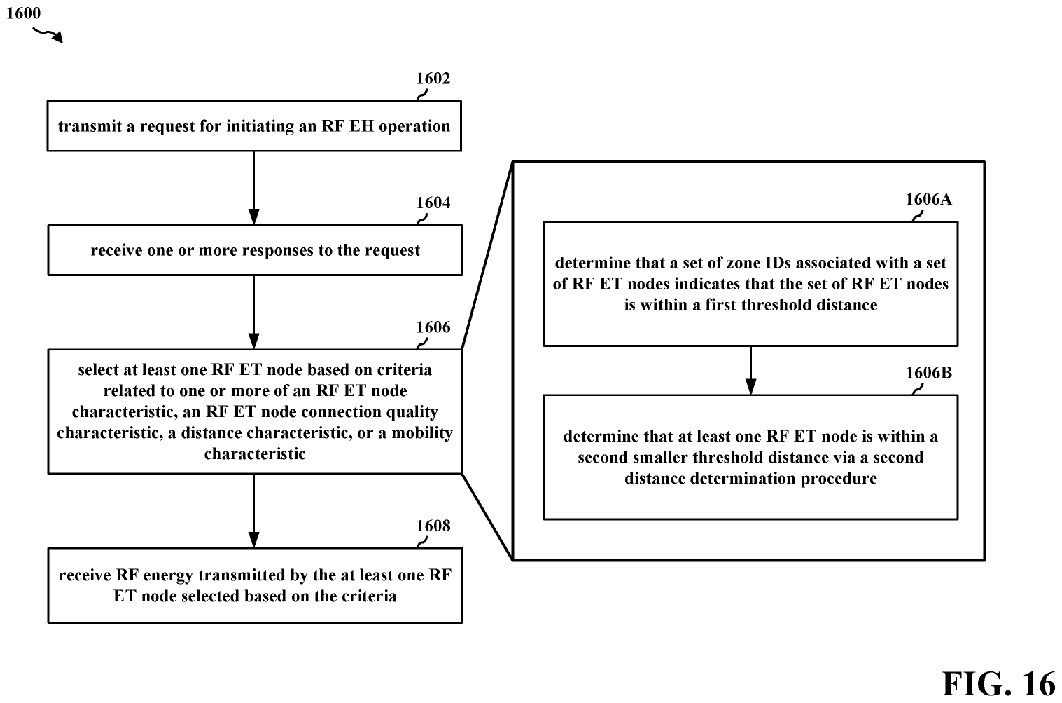

FIG. 16 is a flowchart 1600 of a method of wireless communication. The method may be performed by a device (e.g., the UE 104/610/802/902/1002; the target device 1104/1204/1304; the apparatus 2102). At 1602, the UE (or target device) may transmit a request for initiating an RF EH operation. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 8-10, the EH device 802/902/1002 may transmit a request 806/906A/1006 to a set of RF ET nodes 804, a base station 903, or an RF ET node 1004. For example, 1602 may be performed by an RF EH request component 2140.

At 1604, the UE (or target device) may receive one or more responses to the request. The response, received at 1604, may include an indication of support for one or more of (1) the separated-receiver-based EH indicated in the request, (2) the time-switching-based EH indicated in the request, (3) the power-splitting-based EH indicated in the request, (4) an EH session of the duration indicated in the request, (5) at least one waveform in the set of one or more waveforms indicated in the request, or (6) support for a periodicity and interval for ET. In some aspects, the response, at 1604, may also, or alternatively, include an indication that a particular RF ET node is not available and an indication of a time after which an additional request may be transmitted by the EH-capable UE. For example, referring to FIGS. 8-10, the EH device 802/902/1002 may receive a response 808/908/1008 from a set of RF ET nodes 804/904 or an RF ET node 1004. For example, 1604 may be performed by an RF EH request component 2140.

At 1606, the UE (or target device) may select at least one RF ET node based on criteria related to one or more of an RF ET node characteristic, an RF ET node connection quality characteristic, a distance characteristic, or a mobility characteristic. The RF ET node characteristic criteria may include (e.g., the selection may be based on) at least one of (1) support of separated-receiver-based EH, (2) support of time-switching-based EH, (3) support of power-splitting-based EH, (4) support for a duration of an EH session, (5) support for a periodicity and interval for ET, or (6) a waveform supported for ET.

In some aspects, the criteria related to connection quality characteristics may include (e.g., the selection may be based on) one or more criteria related to at least one of (1) a channel power threshold for ET, (2) an established connection with the EH-capable UE, or (3) a type of communication between the at least one RF ET node and the EH-capable UE. For example, the UE (or target device) may measure an RSRP associated with a transmission from an RF ET node to the UE (or target device) to determine if the measured RSRP is above a threshold for ET. The RSRP threshold for ET may be different from a RSRP threshold for SL communication and/or a threshold for SL communication may be based on a different measured characteristic (e.g., RSRQ, SNR, etc.). In some aspects, the UE (or target device) may select an RF ET node based on the RF ET node being in communication with the UE (or target device) and having previously performed a connection process (e.g., beam sweeping, beam refinement, etc.). The criteria related to the type of communication may include a traffic density threshold of the communication between the RF ET node and the EH-capable UE such that a connected RF ET node is not selected for a communication session in the presence of a threshold traffic density (e.g., more than 70%, 80%, or 90% of available slots containing data). The criteria related to the type of communication may also include whether the connection employs specific formats (e.g., URLLC or eMBB). The communication format may be considered independently and/or may be associated with different traffic density thresholds (e.g., a first traffic density threshold associated with URLLC and a second, higher or lower, traffic density threshold associated with eMBB).

The criteria related to distance characteristics, in some aspects, may include a threshold distance between the EH-capable UE and the at least one RF ET node. In some aspects, the distance (or a distance determination) is based on one or more of (1) a positioning procedure, (2) measurement of a reference signal from the RF ET node, (3) known positions of the UE (or target device) and the RF ET node, (4) at least one zone ID indicated in SL control information, or (5) a location management function. The threshold distance may be different for different types of RF ET nodes based on an advertised transmission power capability. For example, a small cell base station, a mobile device, a laptop, or a wearable device may each be capable of different transmission powers that are each associated with different threshold distances. Additionally, each device may be associated with (e.g., may advertise) a different transmission power capability based on a state of the device (e.g., plugged in to a power source, high battery power, low battery power, etc.).

For example, referring to FIGS. 8-12, the distance between the EH device 802/902/1002 (or target device 1104/1204) and a particular RF ET node (e.g., RF ET node 1004) in a set of candidate RF ET nodes 804/904/1106/1108/1206/1208 may be estimated based on a calculated or known position of the two devices based on a positioning procedure. For example, a position of the devices may be determined based on multi-/single-cell and device-based positioning, a positioning reference signal (PRS) used by various 5G positioning techniques such as roundtrip time (RTT), angle of arrival/departure (AoA/AoD), and time difference of arrival (TDOA). In some aspects, a location management function (e.g., a location server) may be used to determine the distance.

Referring to FIGS. 8-12, a zone ID associated with the RF source, e.g., ET device 1106/1108/1206/1208 and the UE (or target device), e.g., target device 1104/1204 (corresponding to EH-capable EH device 802/902/1002), may be used, in some aspects, to estimate a distance. The zone ID may be a newly-defined zone ID (as described in relation to FIG. 12) identifying spatial areas defined for EH operations such that the zone IDs can be used to independently estimate a distance without additional information.

At 1606A, the UE (or target device) may determine that a set of zone IDs associated with a set of RF ET nodes indicates that the set of RF ET nodes is within a first threshold distance. For example, a zone ID (either a legacy zone ID or a newly-defined zone ID) may be used as a first pass filter to determine that a first set of RF ET nodes 1106 and 1108 (or 1206 and 1208) is within a first threshold distance of the target device 1104/1204 (corresponding to EH device 802/902/1002). For example, for a threshold distance of one zone (e.g., including adjacent zones), the set of ET devices 1106/1108/1208 may be determined to be within one zone of the target device 1104/1204, while for a threshold distance of two zones, the set of ET devices 1206/1208 may be determined to be within two zones of the target device 1204 (as described in relation to 810A/912A). For example, 1606A may be performed by RF EH peer selection component 2142.

At 1606B, a second distance determination procedure as discussed above may be employed to determine whether RF ET devices 1106/1108/1206/1208 that are determined to be within the first threshold distance are within a second, smaller threshold distance 1180 or 1190 (e.g., meets a second distance-based criterion). The second determination, in some aspects, may relate to a received power measurement employed to determine 810B/912B whether a transmission from an RF ET node that is determined to be within the first threshold distance is received with a power that is above a power (e.g., RSRP) threshold (e.g., meets a second power-based criterion). The two step distance-based or distance-and-power-based selection reduce the number of distance determinations (or power measurements) that are made to select the RF ET devices for the EH operation. For example, 1606B may be performed by RF EH peer selection component 2142.

In some aspects, the criteria related to mobility characteristics may include (e.g., the selection may be based on) one or more criteria related to at least one of (1) a mobility state of the at least one RF ET node, (2) a mobility state of the EH-capable UE, or (3) a relative mobility state of the at least one RF ET node and the EH-capable UE. For example, referring to FIGS. 8, 9, and 13, a EH device 802/902/1304/1314 may use information regarding the mobility of an RF ET node 1306/1308/1312/1316/1318 and its own mobility to determine that the two devices are moving away from each other at a rate that is, or is not, below a threshold rate (V_{Thresh}) and that the RF ET node is, or is not, a preferred RF ET node for an EH operation. The determination may be performed as part of a selection as described in relation to selection 810/912. For example, the selection of the at least one RF ET node at 1606 may be performed by RF EH peer selection component 2142.

At 1608, the UE (or target device) may receive RF energy transmitted by the at least one RF ET node selected at 1606. For example, referring to FIGS. 8-13, based on the selection of at least one RF ET node (as described above), the EH device 802/902/1002/1104/1204/1304/1314 may receive RF energy from a set of ET devices (nodes) 804A/904A/1004/1108/1206/1208/1308. For example, 1608 may be performed by RF EH component 2144.

FIG. 17 is a flowchart 1700 of a method of wireless communication. The method may be performed by a base station (e.g., the base station 102/180/602/903/1102/1202; the apparatus 2302). At 1702, the base station may receive a request for initiating an RF EH operation for an EH-capable UE. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 9, the base station 903 may receive a request 906A from a EH-capable EH device 902. For example, 1702 may be performed by an RF EH request component 2340.

At 1704, the base station may select at least one RF ET node to transfer RF energy to the EH-capable UE based on criteria related to one or more of (1) an RF ET node characteristic, (2) an RF ET node connection quality characteristic, (3) a distance characteristic, or (4) a mobility characteristic. For example, referring to FIG. 9, the base station 903 may select at least one RF ET node (e.g., RF ET nodes 904A) in the set of RF ET nodes 904. In some aspects, the selection is based on a response 908 from the set of RF ET nodes 904. The response 908 may include information (and the selection may be based on) at least one of (1) support of separated-receiver-based EH, (2) support of time-switching-based EH, (3) support of power-splitting-based EH, (4) support for a duration of an EH session, (5) support for a periodicity and interval for ET, or (6) a waveform supported for ET.

In some aspects, the criteria related to connection quality characteristics may include (e.g., the selection may be based on) one or more criteria related to at least one of (1) a channel power threshold for ET, (2) an established connection with the EH-capable UE, or (3) a type of communication between the at least one RF ET node and the EH-capable UE. For example, the base station may measure an RSRP associated with a transmission from an RF ET node to the base station to determine if the measured RSRP is above a threshold for ET. The RSRP threshold for ET may be different from a RSRP threshold for SL communication and/or a threshold for SL communication may be based on a different measured characteristic (e.g., RSRQ, SNR, etc.). In some aspects, the base station may select an RF ET node based on the RF ET node being in communication with the base station and having previously performed a connection process (e.g., beam sweeping, beam refinement, etc.). The criteria related to the type of communication may include a traffic density threshold of the communication between the RF ET node and the EH-capable UE such that a connected RF ET node is not selected for a communication session in the presence of a threshold traffic density (e.g., more than 70%, 80%, or 90% of available slots containing data). The criteria related to the type of communication may also include whether the connection employs specific formats (e.g., URLLC or eMBB). The communication format may be considered independently and/or may be associated with different traffic density thresholds (e.g., a first traffic density threshold associated with URLLC and a second, higher or lower, traffic density threshold associated with eMBB).

The criteria related to distance characteristics, in some aspects, may include a threshold distance between the EH-capable UE and the at least one RF ET node. In some aspects, the distance (or a distance determination) is based on one or more of (1) a positioning procedure, (2) measurement of a reference signal from the RF ET node, (3) known positions of the base station and the RF ET node, (4) at least one zone ID indicated in SL control information, or (5) a location management function. The threshold distance may be different for different types of RF ET nodes based on an advertised transmission power capability. For example, a small cell base station, a mobile device, a laptop, or a wearable device may each be capable of different transmission powers that are each associated with different threshold distances. Additionally, each device may be associated with (e.g., may advertise) a different transmission power capability based on a state of the device (e.g., plugged in to a power source, high battery power, low battery power, etc.).

For example, referring to FIGS. 8-12, the distance between the EH device 802/902/1002 (or target device 1104/1204) and a particular RF ET node (e.g., RF ET node 1004) in a set of candidate RF ET nodes 804/904/1106/1108/1206/1208 may be estimated based on a calculated or known position of the two devices based on a positioning procedure. For example, a position of the devices may be determined based on multi-/single-cell and device-based positioning, a positioning reference signal (PRS) used by various 5G positioning techniques such as roundtrip time (RTT), angle of arrival/departure (AoA/AoD), and time difference of arrival (TDOA). In some aspects, a location management function (e.g., a location server) may be used to determine the distance.

Referring to FIGS. 8-12, a zone ID associated with the RF source, e.g., ET device 1106/1108/1206/1208 and the UE (or target device), e.g., target device 1104/1204 (corresponding to EH-capable EH device 802/902/1002), may be used, in some aspects, to estimate a distance. The zone ID may be a newly-defined zone ID (as described in relation to FIG. 12) identifying spatial areas defined for EH operations such that the zone IDs can be used to independently estimate a distance without additional information. Alternatively, a zone ID (either a legacy zone ID or a newly-defined zone ID) may be used as a first pass filter to determine that a first set of RF ET nodes 1106 and 1108 (or 1206 and 1208) is within a first threshold distance of the target device 1104/1204 (corresponding to EH device 802/902/1002). For example, for a threshold distance of one zone (e.g., including adjacent zones), the set of ET devices 1106/1108/1208 may be determined to be within one zone of the target device 1104/1204, while for a threshold distance of two zones, the set of ET devices 1206/1208 may be determined to be within two zones of the target device 1204 (as described in relation to 912A).

A second distance determination procedure as discussed above may be employed to determine whether RF ET devices 1106/1108/1206/1208 that are determined to be within the first threshold distance are within a second, smaller threshold distance 1180 or 1190 (e.g., meets a second distance-based criterion). The second determination, in some aspects, may relate to a received power measurement employed to determine 912B whether a transmission from an RF ET node that is determined to be within the first threshold distance is received with a power that is above a power (e.g., RSRP) threshold (e.g., meets a second power-based criterion). The two step distance-based or distance-and-power-based selection reduce the number of distance determinations (or power measurements) that are made to select the RF ET devices for the EH operation.

In some aspects, the criteria related to mobility characteristics may include (e.g., the selection may be based on) one or more criteria related to at least one of (1) a mobility state of the at least one RF ET node, (2) a mobility state of the EH-capable UE, or (3) a relative mobility state of the at least one RF ET node and the EH-capable UE. For example, referring to FIGS. 9, a base station 903 may use information regarding the mobility of an RF ET node 1306/1308/1312/1316/1318 and its own mobility to determine that the two devices are moving away from each other at a rate that is, or is not, below a threshold rate (V_{Thresh}) and that the RF ET node is, or is not, a preferred RF ET node for an EH operation. The determination may be performed as part of a selection as described in relation to selection 912. For example, the selection of the at least one RF ET node at 1704 may be performed by RF EH peer selection component 2342.

Finally, at 1706, the base station may indicate for the selected at least one RF ET node to transmit the RF energy to the EH-capable UE. In some aspects, the base station may also indicate for the EH-capable UE to receive the RF energy from the selected ate least one RF ET node. For example, referring to FIG. 9, the base station 903 may transmit a selection indication 914A to a set of selected RF ET nodes 904A and may also transmit a selection indication 914B to an EH-capable EH device 902. For example, the selection of the at least one RF ET node at 1704 may be performed by RF EH peer selection component 2342.

FIG. 18 is a flowchart 1800 of a method of wireless communication. The method may be performed by a base station (e.g., the base station 102/180/602/903/1102/1202; the apparatus 2302). At 1802, the base station may receive a request for initiating an RF EH operation for an EH-capable UE. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 9, the base station 903 may receive a request 906A from a EH-capable EH device 902. For example, 1802 may be performed by an RF EH request component 2340.

At 1804, the base station may receive a response from at least one RF ET node. For example, referring to FIG. 9, the base station 903 may receive the response 908 from the set of RF ET nodes 904. The response 908 may include information regarding at least one of (1) support of separated-receiver-based EH, (2) support of time-switching-based EH, (3) support of power-splitting-based EH, (4) support for a duration of an EH session, (5) support for a periodicity and interval for ET, or (6) a waveform supported for ET. For example, 1804 may be performed by an RF EH request component 2340.

At 1806, the base station may select at least one RF ET node to transfer RF energy to the EH-capable UE based on criteria related to one or more of (1) an RF ET node characteristic, (2) an RF ET node connection quality characteristic, (3) a distance characteristic, or (4) a mobility characteristic. For example, referring to FIG. 9, the base station 903 may select at least one RF ET node (e.g., RF ET nodes 904A) in the set of RF ET nodes 904.

In some aspects, the criteria related to connection quality characteristics may include (e.g., the selection may be based on) one or more criteria related to at least one of (1) a channel power threshold for ET, (2) an established connection with the EH-capable UE, or (3) a type of communication between the at least one RF ET node and the EH-capable UE. For example, the base station may measure an RSRP associated with a transmission from an RF ET node to the base station to determine if the measured RSRP is above a threshold for ET. The RSRP threshold for ET may be different from a RSRP threshold for SL communication and/or a threshold for SL communication may be based on a different measured characteristic (e.g., RSRQ, SNR, etc.). In some aspects, the base station may select an RF ET node based on the RF ET node being in communication with the base station and having previously performed a connection process (e.g., beam sweeping, beam refinement, etc.). The criteria related to the type of communication may include a traffic density threshold of the communication between the RF ET node and the EH-capable UE such that a connected RF ET node is not selected for a communication session in the presence of a threshold traffic density (e.g., more than 70%, 80%, or 90% of available slots containing data). The criteria related to the type of communication may also include whether the connection employs specific formats (e.g., URLLC or eMBB). The communication format may be considered independently and/or may be associated with different traffic density thresholds (e.g., a first traffic density threshold associated with URLLC and a second, higher or lower, traffic density threshold associated with eMBB).

The criteria related to distance characteristics, in some aspects, may include a threshold distance between the EH-capable UE and the at least one RF ET node. In some aspects, the distance (or a distance determination) is based on one or more of (1) a positioning procedure, (2) measurement of a reference signal from the RF ET node, (3) known positions of the base station and the RF ET node, (4) at least one zone ID indicated in SL control information, or (5) a location management function. The threshold distance may be different for different types of RF ET nodes based on an advertised transmission power capability. For example, a small cell base station, a mobile device, a laptop, or a wearable device may each be capable of different transmission powers that are each associated with different threshold distances. Additionally, each device may be associated with (e.g., may advertise) a different transmission power capability based on a state of the device (e.g., plugged in to a power source, high battery power, low battery power, etc.).

For example, referring to FIGS. 8-12, the distance between the EH device 802/902/1002 (or target device 1104/1204) and a particular RF ET node (e.g., RF ET node 1004) in a set of candidate RF ET nodes 804/904/1106/1108/1206/1208 may be estimated based on a calculated or known position of the two devices based on a positioning procedure. For example, a position of the devices may be determined based on multi-/single-cell and device-based positioning, a positioning reference signal (PRS) used by various 5G positioning techniques such as roundtrip time (RTT), angle of arrival/departure (AoA/AoD), and time difference of arrival (TDOA). In some aspects, a location management function (e.g., a location server) may be used to determine the distance.

Referring to FIGS. 8-12, a zone ID associated with the RF source, e.g., ET device 1106/1108/1206/1208 and the UE (or target device), e.g., target device 1104/1204 (corresponding to EH-capable EH device 802/902/1002), may be used, in some aspects, to estimate a distance. The zone ID may be a newly-defined zone ID (as described in relation to FIG. 12) identifying spatial areas defined for EH operations such that the zone IDs can be used to independently estimate a distance without additional information.

At 1806A, may determine that a set of zone IDs associated with a set of RF ET nodes indicates that the set of RF ET nodes is within a first threshold distance. For example, a zone ID (either a legacy zone ID or a newly-defined zone ID) may be used as a first pass filter to determine that a first set of RF ET nodes 1106 and 1108 (or 1206 and 1208) is within a first threshold distance of the target device 1104/1204 (corresponding to EH device 802/902/1002). For example, for a threshold distance of one zone (e.g., including adjacent zones), the set of ET devices 1106/1108/1208 may be determined to be within one zone of the target device 1104/1204, while for a threshold distance of two zones, the set of ET devices 1206/1208 may be determined to be within two zones of the target device 1204 (as described in relation to 912A). For example, 1806A may be performed by RF EH peer selection component 2342.

At 1806B, a second distance determination procedure as discussed above may be employed to determine whether RF ET devices 1106/1108/1206/1208 that are determined to be within the first threshold distance are within a second, smaller threshold distance 1180 or 1190 (e.g., meets a second distance-based criterion). The second determination, in some aspects, may relate to a received power measurement employed to determine 912B whether a transmission from an RF ET node that is determined to be within the first threshold distance is received with a power that is above a power (e.g., RSRP) threshold (e.g., meets a second power-based criterion). The two step distance-based or distance-and-power-based selection reduce the number of distance determinations (or power measurements) that are made to select the RF ET devices for the EH operation. For example, 1806A may be performed by RF EH peer selection component 2342.

In some aspects, the criteria related to mobility characteristics may include (e.g., the selection may be based on) one or more criteria related to at least one of (1) a mobility state of the at least one RF ET node, (2) a mobility state of the EH-capable UE, or (3) a relative mobility state of the at least one RF ET node and the EH-capable UE. For example, referring to FIGS. 9, a base station 903 may use information regarding the mobility of an RF ET node 1306/1308/1312/1316/1318 and its own mobility to determine that the two devices are moving away from each other at a rate that is, or is not, below a threshold rate (V_{Thresh}) and that the RF ET node is, or is not, a preferred RF ET node for an EH operation. The determination may be performed as part of a selection as described in relation to selection 912. For example, the selection of the at least one RF ET node at 1806 may be performed by RF EH peer selection component 2342.

Finally, at 1808, the base station may indicate for the selected at least one RF ET node to transmit the RF energy to the EH-capable UE. In some aspects, the base station may also indicate for the EH-capable UE to receive the RF energy from the selected ate least one RF ET node. For example, referring to FIG. 9, the base station 903 may transmit a selection indication 914A to a set of selected RF ET nodes 904A and may also transmit a selection indication 914B to an EH-capable EH device 902. For example, the selection of the at least one RF ET node at 1806 may be performed by RF EH peer selection component 2342.

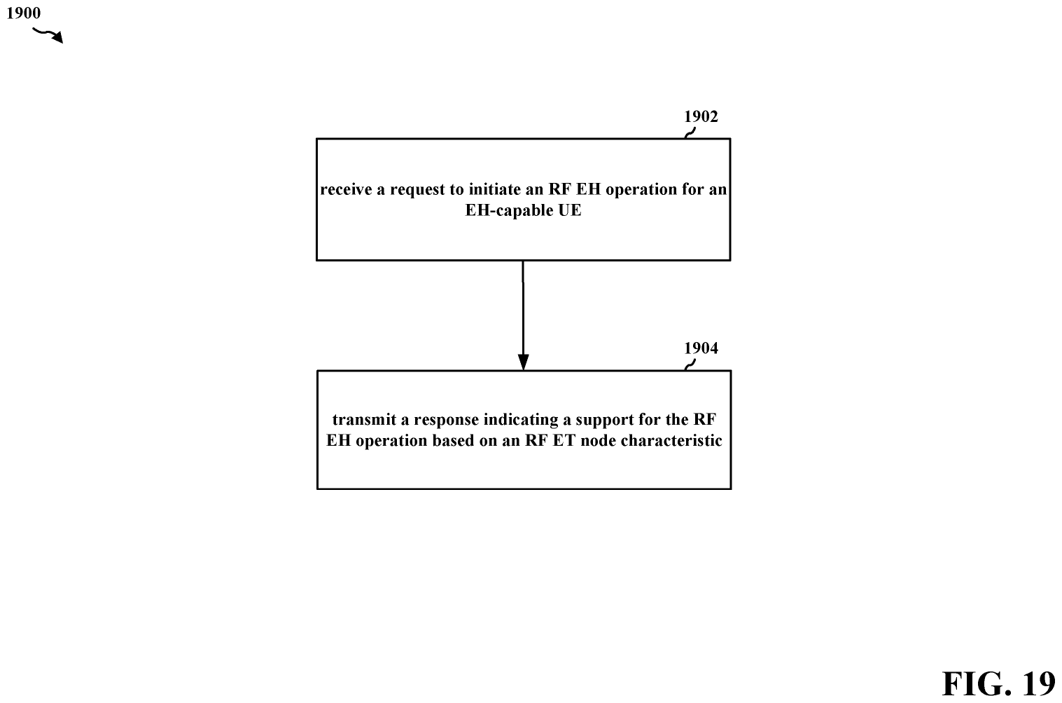

FIG. 19 is a flowchart 1900 of a method of wireless communication. The method may be performed by an ET device (e.g., the UE 104/612; RF ET node 804/904/1004; the RF ET device 1106/1108/1206/1208/1306/1308/ 1316/1318; the apparatus 2202). At 1902, the device may receive a request for initiating an RF EH operation for an EH-capable UE. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 8-10, the device 804/904/1004 may receive a request 806/906B/1006 from a EH device 802/1002 or a base station 903. For example, 1902 may be performed by an RF EH request component 2240.

At 1904, the device may transmit one or more responses to the request. The response, at 1904, may include an indication of support for one or more of (1) the separated-receiver-based EH indicated in the request, (2) the time-switching-based EH indicated in the request, (3) the power-splitting-based EH indicated in the request, (4) an EH session of the duration indicated in the request, (5) at least one waveform in the set of one or more waveforms indicated in the request, or (6) support for a periodicity and interval for ET. In some aspects, the response, at 1904, may also, or alternatively, include an indication that a particular RF ET node is not available and an indication of a time after which an additional request may be transmitted by the EH-capable UE. For example, referring to FIGS. 8-10, the EH device 802/902/1002 may receive a response 808/908/1008 from a set of RF ET nodes 804/904 or an RF ET node 1004. For example, 1904 may be performed by an RF EH request component 2240.

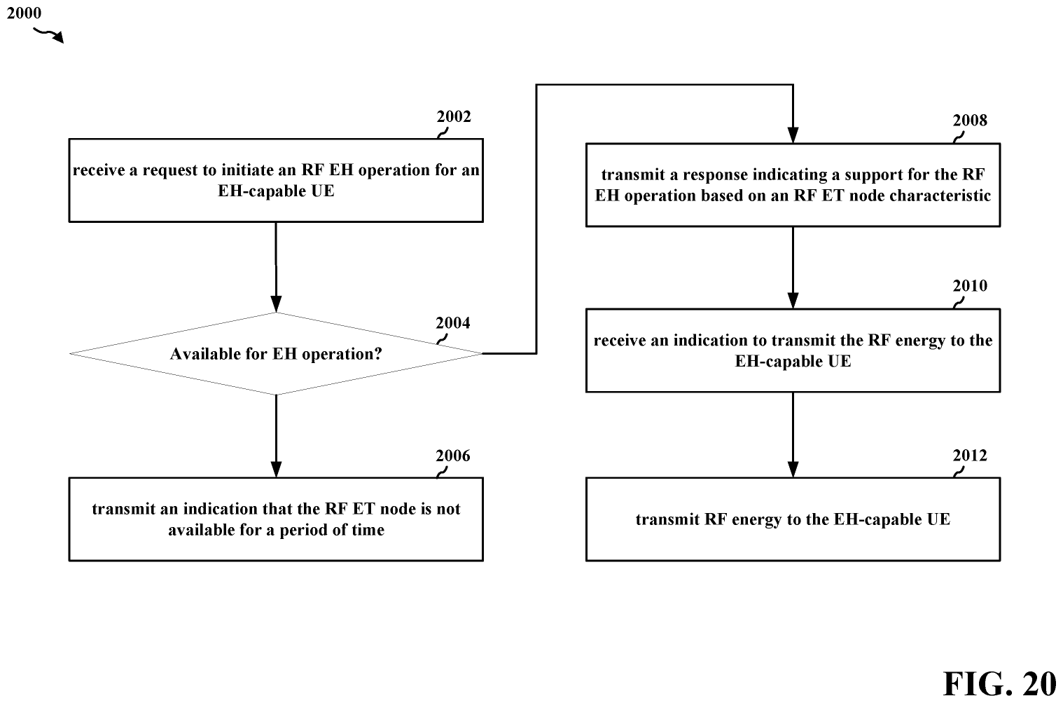

FIG. 20 is a flowchart 2000 of a method of wireless communication. The method may be performed by a device (e.g., the UE 104/612; the RF ET nodes 804/904/1004; the RF ET device 1106/1108/1206/1208/1306/1308/ 1316/1318; the apparatus 2202). At 2002, the device may receive a request for initiating an RF EH operation for an EH-capable UE. The request for RF energy harvesting operation may include an indication of support, or a request by the EH-capable UE, for one or more of (1) separated-receiver-based EH, (2) time-switching-based EH, (3) power-splitting-based EH, (4) a duration of an EH session, or (5) a set of one or more waveforms for ET. For example, referring to FIGS. 8-10, the device 804/904/1004 may receive a request 806/906B/1006 from a EH device 802/1002 or a base station 903. For example, 2002 may be performed by an RF EH request component 2240.

At 2004, the device may determine whether the device is available to provide RF energy to the EH-capable UE associated with the request. In some aspects, the determination is based on a traffic density threshold. For example, referring to FIGS. 8-10, for an RF ET device 1004 that is engaged in communication with a traffic density above the traffic density threshold the device may determine that the RF ET device is not available for an RF ET/EH operation, while an RF ET device in a set of RF ET devices 804/904 that is not engaged in communication with a traffic density above the traffic density threshold may determine that the RF ET device is available for an RF ET/EH operation. The traffic density threshold may be based on a preferred EH resource density (e.g., no less than 10%, 20%, 50%, etc. of resources available for EH operations).

If the device determines, at 2004, that the device is not available for an EH operation, the device may transmit, at 2006, an indication that the RF ET node is not available for a period of time (e.g., an expiration time). For example, the expiration time may indicate a time after which an EH-capable UE associated with the request received at 2002 may transmit another request for an EH operation. The period of time (e.g., the expiration time) may be (pre)configured or may be determined based on current communication characteristics (e.g., a queue filling ratio, congestion measure, scheduled transmissions, etc.). For example, referring to FIG. 10, an RF ET node 1004 may transmit a response 1008 including an RF ET expiration timer.

If the device determines, at 2004, that the device is available for an EH operation, the device may transmit, at 2008, the device may transmit a response indicating a support for the RF EH operation based on an RF ET node characteristic. The response, at 2008, may include an indication of support for one or more of (1) the separated-receiver-based EH indicated in the request, (2) the time-switching-based EH indicated in the request, (3) the power-splitting-based EH indicated in the request, (4) an EH session of the duration indicated in the request, (5) at least one waveform in the set of one or more waveforms indicated in the request, or (6) support for a periodicity and interval for ET. For example, referring to FIGS. 8-10, an RF ET node in a set of RF ET nodes 804/904 or an RF ET node 1002 may transmit a response 808/908/1008 to a EH device 802/1002 or a base station 903. For example, 2004-2008 may be performed by an RF EH request component 2240.

At 2010, the device may receive an indication to transmit the RF energy to the EH-capable UE. The indication may be received from the EH-capable UE or from a base station. For example, referring to FIGS. 8 and 9, the set of RF ET nodes 804A/904A may receive a selection indication 812/914A from a EH device 802 or from a base station 903. For example, 2010 may be performed by an RF ET component 2242.

Finally, at 2012, the device may transmit RF energy to the EH-capable node. For example, referring to FIGS. 8-13, based on a selection of at least one RF ET node, as described below, the at least one RF ET node, e.g., a set of ET devices (nodes) 804A/904A/1004/1108/1206/1208/1308 may transmit RF energy to the EH device 802/902/1002/1104/1204/1304/1314.

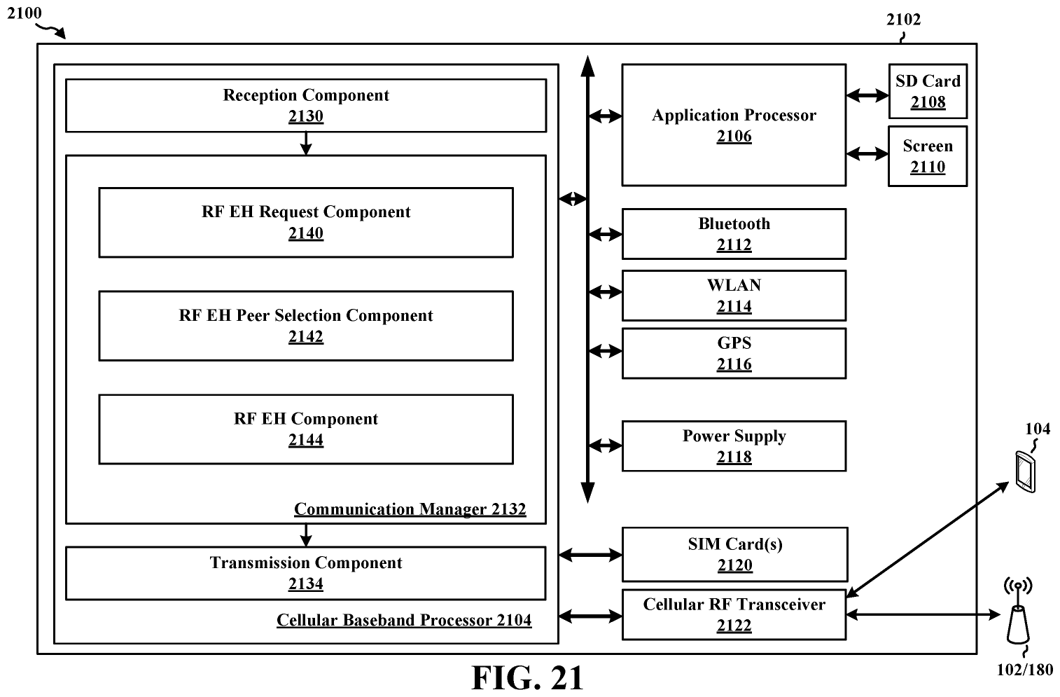

FIG. 21 is a diagram 2100 illustrating an example of a hardware implementation for an apparatus 2102. The apparatus may be an EH device, a component of an EH device, or may implement EH functionality. In some aspects, the apparatus 2102 may be a UE, a component of a UE, or may implement UE functionality. In some aspects, the apparatus 2102 may include a cellular baseband processor 2104 (also referred to as a modem) coupled to a cellular RF transceiver 2122. In some aspects, the apparatus 2102 may further include one or more subscriber identity modules (SIM) cards 2120, an application processor 2106 coupled to a secure digital (SD) card 2108 and a screen 2110, a Bluetooth module 2112, a wireless local area network (WLAN) module 2114, a Global Positioning System (GPS) module 2116, or a power supply 2118. The cellular baseband processor 2104 communicates through the cellular RF transceiver 2122 with the UE 104 and/or BS 102/180. The cellular baseband processor 2104 may include a computer-readable medium/memory. The computer-readable medium/memory may be non-transitory. The cellular baseband processor 2104 is responsible for general processing, including the execution of software stored on the computer-readable medium/memory. The software, when executed by the cellular baseband processor 2104, causes the cellular baseband processor 2104 to perform the various functions described supra. The computer-readable medium/memory may also be used for storing data that is manipulated by the cellular baseband processor 2104 when executing software. The cellular baseband processor 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the cellular baseband processor 2104. The cellular baseband processor 2104 may be a component of the UE 350 and may include the memory 360 and/or at least one of the TX processor 368, the RX processor 356, and the controller/processor 359. In one configuration, the apparatus 2102 may be a modem chip and include just the baseband processor 2104, and in another configuration, the apparatus 2102 may be the entire UE (e.g., see 350 of FIG. 3) and include the additional modules of the apparatus 2102.

The communication manager 2132 includes an RF EH request component 2140 that is configured to transmit a request for initiating an RF EH operation and receive one or more responses to the request, e.g., as described in connection with 1402, 1404, 1502, 1504, 1602, and 1604 of FIGS. 14-16. The communication manager 2132 further includes an RF EH peer selection component 2142 that receives input in the form of the information included in the received responses to the request from the component 2140 and is configured to receive an indication from a network to receive the RF energy from at least one RF ET node and/or select at least one RF ET node based on criteria related to one or more of an RF ET node characteristic, an RF ET node connection quality characteristic, a distance characteristic, or a mobility characteristic, e.g., as described in connection with 1506, 1606, 1606A, and 1606B of FIGS. 15 and 16. The communication manager 2132 further includes an RF EH component 2144 that receives input in the form of a selection of a set of RF ET nodes/devices from the component 2142 and is configured to receive RF energy transmitted by the at least one RF ET node selected (either by the EH-capable UE or a base station) based on the criteria, e.g., as described in connection with 1406, 1508, and 1608 of FIGS. 14-16.

The apparatus may include additional components that perform each of the blocks of the algorithm in the flowcharts of FIGS. 14-16. As such, each block in the flowcharts of FIGS. 14-16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2102 may include a variety of components configured for various functions. In one configuration, the apparatus 2102, and in particular the cellular baseband processor 2104, includes means for transmitting a request for initiating an RF EH operation. The apparatus 2102, and in particular the cellular baseband processor 2104, may further include means for receiving one or more responses to the request. The apparatus 2102, and in particular the cellular baseband processor 2104, may further include means for receiving RF energy transmitted by at least one RF ET node selected based on criteria related to one or more of an RF ET node characteristic, an RF ET node connection quality characteristic, a distance characteristic, or a mobility characteristic. The apparatus 2102, and in particular the cellular baseband processor 2104, may further include means for selecting, at the EH-capable UE, the at least one RF ET node based on the criteria. The apparatus 2102, and in particular the cellular baseband processor 2104, may further include means for receiving an indication from a network to receive the RF energy from the at least one RF ET node. The apparatus 2102, and in particular the cellular baseband processor 2104, may further include means for determining that a set of zone IDs associated with a set of RF ET nodes including the at least one RF ET node indicates that the set of RF ET nodes is within a first threshold distance. The apparatus 2102, and in particular the cellular baseband processor 2104, may further include means for determining that the at least one RF ET node is within a second smaller threshold distance via a second distance determination procedure. The means may be one or more of the components of the apparatus 2102 configured to perform the functions recited by the means. As described supra, the apparatus 2102 may include the TX Processor 368, the RX Processor 356, and the controller/processor 359. As such, in one configuration, the means may be the TX Processor 368, the RX Processor 356, and the controller/processor 359 configured to perform the functions recited by the means.

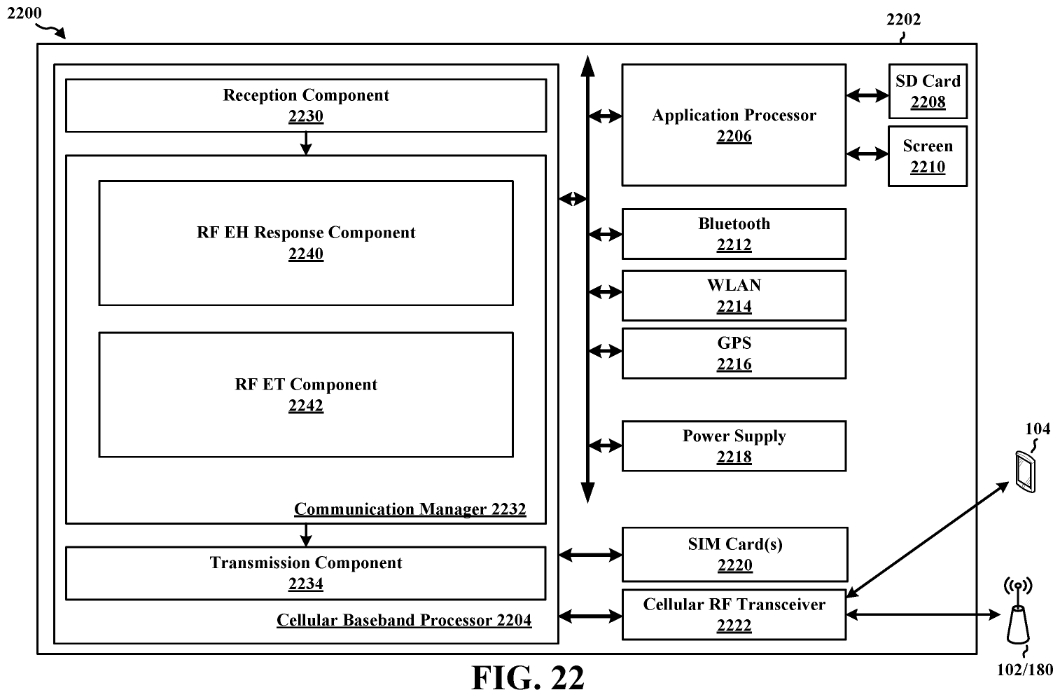

FIG. 22 is a diagram 2200 illustrating an example of a hardware implementation for an apparatus 2202. The apparatus 2202 may be an ET node, a component of an ET node, or may implement ET node functionality. In some aspects, the apparatus 2202 may be a UE, a component of a UE, or may implement UE functionality. In some aspects, the apparatus 2202 may be a base station (e.g., for a small cell) or a CPE, a component of a base station/CPE, or may implement base station/CPE functionality. In some aspects, the apparatus 2202 may include a cellular baseband processor 2204 (also referred to as a modem) coupled to a cellular RF transceiver 2222. In some aspects, the apparatus 2202 may further include one or more subscriber identity modules (SIM) cards 2220, an application processor 2206 coupled to a secure digital (SD) card 2208 and a screen 2210, a Bluetooth module 2212, a wireless local area network (WLAN) module 2214, a Global Positioning System (GPS) module 2216, or a power supply 2218. The cellular baseband processor 2204 communicates through the cellular RF transceiver 2222 with the UE 104 and/or BS 102/180. The cellular baseband processor 2204 may include a computer-readable medium/memory. The computer-readable medium/memory may be non-transitory. The cellular baseband processor 2204 is responsible for general processing, including the execution of software stored on the computer-readable medium/memory. The software, when executed by the cellular baseband processor 2204, causes the cellular baseband processor 2204 to perform the various functions described supra. The computer-readable medium/memory may also be used for storing data that is manipulated by the cellular baseband processor 2204 when executing software. The cellular baseband processor 2204 further includes a reception component 2230, a communication manager 2232, and a transmission component 2234. The communication manager 2232 includes the one or more illustrated components. The components within the communication manager 2232 may be stored in the computer-readable medium/memory and/or configured as hardware within the cellular baseband processor 2204. The cellular baseband processor 2204 may be a component of the UE 350 and may include the memory 360 and/or at least one of the TX processor 368, the RX processor 356, and the controller/processor 359. In one configuration, the apparatus 2202 may be a modem chip and include just the baseband processor 2204, and in another configuration, the apparatus 2202 may be the entire UE (e.g., see 350 of FIG. 3) and include the additional modules of the apparatus 2202.

The communication manager 2232 includes an RF EH response component 2240 that is configured to receive a request for initiating an RF EH operation for an EH-capable UE, transmit an indication that the RF ET node RF ET node is not available for a period of time, transmit a response indicating a support for the RF EH operation based on an RF ET node characteristic, e.g., as described in connection with 1902, 2002, 2006, and 2008 of FIGS. 19 and 20. The communication manager 2232 further includes an RF ET component 2242 that receives input in the form of an indication to transmit the RF energy to the EH-capable UE and is configured to transmit RF energy to the EH-capable UE, e.g., as described in connection with 2010 and 2012.

The apparatus may include additional components that perform each of the blocks of the algorithm in the flowcharts of FIGS. 19 and 20. As such, each block in the flowcharts of FIGS. 19 and 20 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2202 may include a variety of components configured for various functions. In one configuration, the apparatus 2202, and in particular the cellular baseband processor 2204, includes means for receiving a request to initiate an RF EH operation for an EH capable UE. The apparatus 2202, and in particular the cellular baseband processor 2204, may further include means for transmitting a response indicating a support for the RF EH operation based on an RF ET node characteristic. The apparatus 2202, and in particular the cellular baseband processor 2204, may further include means for transmitting RF energy to the EH-capable UE. The apparatus 2202, and in particular the cellular baseband processor 2204, may further include means for receiving an indication from a network to transmit the RF energy to the EH-capable UE. The apparatus 2202, and in particular the cellular baseband processor 2204, may further include means for receiving an indication from the EH-capable UE to transmit the RF energy to the EH capable UE. The apparatus 2202, and in particular the cellular baseband processor 2204, may further include means for transmitting an indication that the RF ET node is not available for a period of time. The means may be one or more of the components of the apparatus 2202 configured to perform the functions recited by the means. As described supra, the apparatus 2202 may include the TX Processor 368, the RX Processor 356, and the controller/processor 359. As such, in one configuration, the means may be the TX Processor 368, the RX Processor 356, and the controller/processor 359 configured to perform the functions recited by the means.

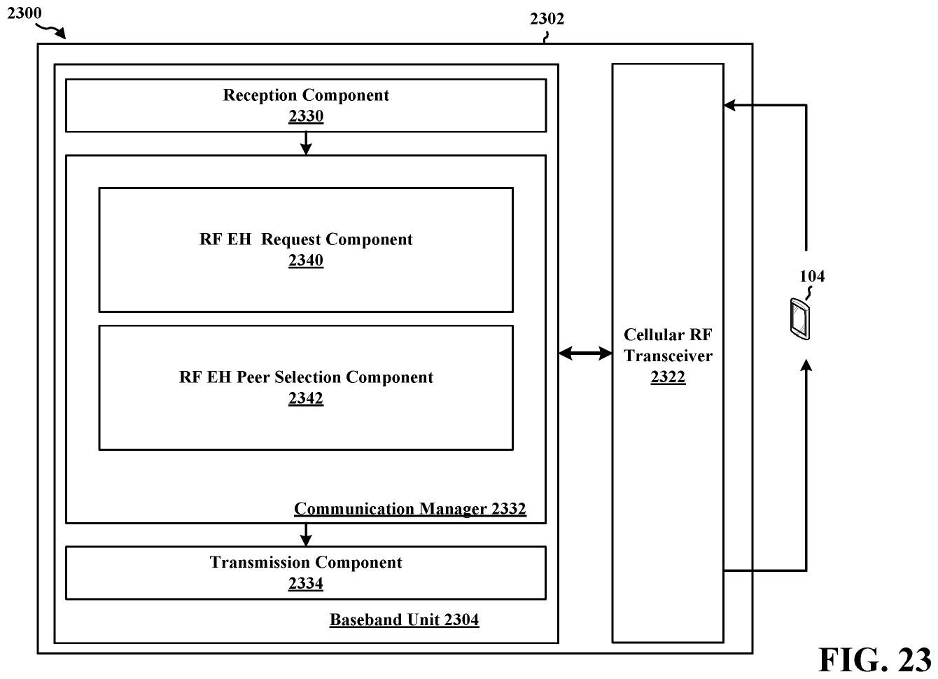

FIG. 23 is a diagram 2300 illustrating an example of a hardware implementation for an apparatus 2302. The apparatus 2302 may be a base station, a component of a base station, or may implement base station functionality. In some aspects, the apparatus 2102 may include a baseband unit 2304. The baseband unit 2304 may communicate through a cellular RF transceiver 2322 with the UE 104. The baseband unit 2304 may include a computer-readable medium/memory. The baseband unit 2304 is responsible for general processing, including the execution of software stored on the computer-readable medium/memory. The software, when executed by the baseband unit 2304, causes the baseband unit 2304 to perform the various functions described supra. The computer-readable medium/memory may also be used for storing data that is manipulated by the baseband unit 2304 when executing software. The baseband unit 2304 further includes a reception component 2330, a communication manager 2332, and a transmission component 2334. The communication manager 2332 includes the one or more illustrated components. The components within the communication manager 2332 may be stored in the computer-readable medium/memory and/or configured as hardware within the baseband unit 2304. The baseband unit 2304 may be a component of the base station 310 and may include the memory 376 and/or at least one of the TX processor 316, the RX processor 370, and the controller/processor 375.

The communication manager 2332 includes an RF EH request component 2340 that may receive a request for initiating an RF EH operation for an EH-capable UE and may receive a response from at least one RF ET node, e.g., as described in connection with 1702, 1802, and 1804 of FIGS. 17 and 18. The communication manager 2332 further includes an RF EH peer selection component 2342 that may select at least one RF ET node to transfer RF energy to the EH-capable UE based on criteria related to one or more of (1) an RF ET node characteristic, (2) an RF ET node connection quality characteristic, (3) a distance characteristic, or (4) a mobility characteristic and may indicate for the selected at least one RF ET node to transmit the RF energy to the EH-capable UE, e.g., as described in connection with 1704, 1706, 1806, 1806A, 1806B, 1808 of FIGS. 17 and 18.

The apparatus may include additional components that perform each of the blocks of the algorithm in the flowcharts of FIGS. 17 and 18. As such, each block in the flowcharts of FIGS. 17 and 18 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2302 may include a variety of components configured for various functions. In one configuration, the apparatus 2302, and in particular the baseband unit 2304, includes means for receiving a request to initiate an RF EH operation for an EH capable UE. The apparatus 2302, and in particular the baseband unit 2304, may also include means for selecting at least one RF ET node to transfer RF energy to the EH-capable UE based on criteria related to one or more of an RF ET node characteristic, an RF ET node connection quality characteristic, a distance characteristic, or a mobility characteristic. The apparatus 2302, and in particular the baseband unit 2304, may also include means for indicating for the selected at least one RF ET node to transmit the RF energy to the EH-capable UE. The apparatus 2302, and in particular the baseband unit 2304, may also include means for receiving a response from an RF ET node that includes an indication that the RF ET node is not available for a period of time. The apparatus 2302, and in particular the baseband unit 2304, may also include means for determining that a set of zone IDs associated with a set of RF ET nodes including the at least one RF ET node indicates that the set of RF ET nodes is within a first threshold distance of the EH-capable UE. The apparatus 2302, and in particular the baseband unit 2304, may also include means for determining that the at least one RF ET node is within a second smaller threshold distance of the EH-capable UE based on a second distance determination procedure. The means may be one or more of the components of the apparatus 2302 configured to perform the functions recited by the means. As described supra, the apparatus 2302 may include the TX Processor 316, the RX Processor 370, and the controller/processor 375. As such, in one configuration, the means may be the TX Processor 316, the RX Processor 370, and the controller/processor 375 configured to perform the functions recited by the means.

As discussed in relation to FIGS. 4-7 above different device may support different architectures, time-and-frequency resources, or different waveforms. Specifically, in a mixed network as described in relation to FIG. 6, different devices may differently support RF ET/EH. In such cases, it may be beneficial to introduce methods for selecting an RF ET peers for an EH operation based on characteristics of at least one of an EH-capable target device (e.g., UE, IoT device, wearable device, etc.) and an ET-capable device, (e.g., base station, UE, IoT device, wearable device, etc.). As described above in relation to FIGS. 8-23, the selection may be based on a number of categories of characteristics, e.g., (1) RF ET node characteristics, (2) RF ET node connection quality characteristics, (3) distance characteristics, or (4) mobility characteristics, each of which can further be broken down into more specific criteria as discussed above.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including at least one processor coupled to a memory and configured to: transmit a request for initiating an RF EH operation; receive one or more responses to the request; and receive RF energy transmitted by at least one RF ET node selected based on criteria related to one or more of an RF ET node characteristic, an RF ET node connection quality characteristic, a distance characteristic, or a mobility characteristic.

Aspect 2 is the apparatus of aspect 1, where the at least one processor is further configured to select, at the apparatus, the at least one RF ET node based on the criteria.

Aspect 3 is the apparatus of aspect 1, where the at least one processor is further configured to receive an indication from a network to receive the RF energy from the at least one RF ET node.

Aspect 4 is the apparatus of any of aspects 1 to 3, where the criteria relates to the RF ET node characteristic; the request includes an indication of support or a request by the apparatus for one or more of: separated-receiver-based EH, time-switching-based EH, power-splitting-based EH, a duration of an EH session, or a set of one or more waveforms for ET; and the response includes an indication of at least one RF ET node characteristic related to support for one or more of: the separated-receiver-based EH indicated in the request, the time-switching-based EH indicated in the request, the power-splitting-based EH indicated in the request, an EH session of the duration indicated in the request, or at least one waveform in the set of one or more waveforms indicated in the request.

Aspect 5 is the apparatus of aspect 4, where the set of one or more waveforms includes one or more of a deterministic signal, a circularly symmetric complex Gaussian random signal, or an improper complex Gaussian random signal.

Aspect 6 is the apparatus of any of aspects 4 and 5, where the response to the request includes an indication that a particular RF ET node is not available and an indication of a time after which an additional request may be transmitted by the apparatus.

Aspect 7 is the apparatus of any of aspects 1 to 6, where the criteria relates to the connection quality characteristic and is based on at least one of: a channel power threshold for ET, an established connection with the apparatus, or a type of communication between the at least one RF ET node and the apparatus.

Aspect 8 is the apparatus of aspect 7, where the channel power threshold for ET is a first RSRP threshold that is different from a second RSRP threshold for SL communication.

Aspect 9 is the apparatus of aspect 7, where the at least one RF ET node includes only RF ET nodes in communication with the apparatus at a time of the request.

Aspect 10 is the apparatus of aspect 7, where the criteria relates to the type of communication between the RF ET node and the apparatus and is based on a data traffic density threshold.

Aspect 11 is the apparatus of any of aspects 1 to 10, where the criteria relates to the distance characteristic and is based on a threshold distance between the apparatus and the at least one RF ET node.

Aspect 12 is the apparatus of aspect 11, where a distance between the apparatus and an RF ET node is based on one or more of: a positioning procedure, measurement of a reference signal from the RF ET node, known positions of the apparatus and the RF ET node, at least one zone ID indicated in SL control information, or a location management function.

Aspect 13 is the apparatus of aspect 12, where the at least one zone ID comprises at least one zone ID associated with the at least one RF ET node that, in addition to a zone ID associated with the apparatus, is used to identify that the RF ET node is within the threshold distance from the apparatus.

Aspect 14 is the apparatus of any of aspects 1 to 12, where selecting the at least one RF ET node based on the criteria related to the distance includes: determining that a set of zone IDs associated with a set of RF ET nodes including the at least one RF ET node indicates that the set of RF ET nodes is within a first threshold distance; and determining that the at least one RF ET node is within a second smaller threshold distance via a second distance determination procedure.

Aspect 15 is the apparatus of any of aspects 1 to 14, where the criteria relates to the mobility characteristic and is based on at least one of: a mobility state of the at least one RF ET node, a mobility state of the apparatus, or a relative mobility state of the at least one RF ET node and the apparatus.

Aspect 16 is an apparatus for wireless communication including at least one processor coupled to a memory and configured to receive a request to: initiate an RF EH operation for an EH capable UE; select at least one RF ET node to transfer RF energy to the EH-capable UE based on criteria related to one or more of an RF ET node characteristic, an RF ET node connection quality characteristic, a distance characteristic, or a mobility characteristic; and indicate for the selected at least one RF ET node to transmit the RF energy to the EH-capable UE.

Aspect 17 is the apparatus of aspect 16, where the criteria relates to the RF ET node characteristic and is based on at least one of: support of separated-receiver-based EH, support of time-switching-based EH, support of power-splitting-based EH, support for a duration of an EH session, support for a periodicity and interval for ET, or a waveform supported for ET.

Aspect 18 is the apparatus of aspect 17, where the request comprises an indication of support or a request by the EH-capable UE for one or more of: separated-receiver-based EH, time-switching-based EH, power-splitting-based EH, a duration of an EH session, or a set of one or more waveforms for ET, the method further including: receiving a response from the at least one RF ET node that comprises an indication of support for one or more of: the separated-receiver-based EH indicated in the request, the time-switching-based EH indicated in the request, the power-splitting-based EH indicated in the request, an EH session of the duration indicated in the request, or at least one waveform in the set of one or more waveforms indicated in the request.

Aspect 19 is the apparatus of any of aspects 16 to 18, where the at least one processor is further configured to receive a response from an RF ET node that includes an indication that the RF ET node is not available for a period of time.

Aspect 20 is the apparatus of any of aspects 16 to 19, where the criteria relates to the connection quality characteristic and is based on at least one of: a channel power threshold for ET, an established connection with the EH-capable UE, or a type of communication between the at least one RF ET node and the EH-capable UE.

Aspect 21 is the apparatus of aspect 20, where the channel power threshold for ET is a first RSRP threshold that is different from a second RSRP threshold for SL communication.

Aspect 22 is the apparatus of any of aspects 20 and 21, where the at least one RF ET node comprises only RF ET nodes in communication with the EH-capable UE at a time of the request.

Aspect 23 is the apparatus of any of aspects 20 to 22, where the criteria relates to the type of communication between the RF ET node and the EH-capable UE and is based on a data traffic density threshold.

Aspect 24 is the apparatus of any of aspects 16 to 23, where the criteria relates to the distance characteristic and is based on a threshold distance between the EH-capable UE and the at least one RF ET node.

Aspect 25 is the apparatus of aspect 24, where a distance between the EH-capable UE and an RF ET node is based on one or more of: a positioning procedure, measurement of a reference signal from the RF ET node, known positions of the EH-capable UE and the RF ET node, at least one zone ID indicated in SL control information, or a location management function.

Aspect 26 is the apparatus of any of aspects 24 and 25, where selecting the at least one RF ET node based on the criteria related to the distance includes: determining that a set of zone IDs associated with a set of RF ET nodes including the at least one RF ET node indicates that the set of RF ET nodes is within a first threshold distance of the EH-capable UE; and determining that the at least one RF ET node is within a second smaller threshold distance of the EH-capable UE based on a second distance determination procedure.

Aspect 27 is the apparatus of any of aspects 16 to 26, where the criteria relates to the mobility characteristic and is based on at least one of: a mobility state of the at least one RF ET node, a mobility state of the EH-capable UE, or a relative mobility state of the at least one RF ET node and the EH-capable UE.

Aspect 28 is an apparatus for wireless communication including at least one processor coupled to a memory and configured to receive a request to initiate an RF EH operation for an EH capable UE; and transmitting a response indicating a support for the RF EH operation based on an RF ET node characteristic.

Aspect 29 is the apparatus of aspect 28, where the at least one processor is further configured to transmit RF energy to the EH-capable UE.

Aspect 30 is the apparatus of aspect 29, where the at least one processor is further configured to receive an indication from a network to transmit the RF energy to the EH-capable UE.

Aspect 31 is the apparatus of aspect 29, where the at least one processor is further configured to receive an indication from the EH-capable UE to transmit the RF energy to the EH capable UE.

Aspect 32 is the apparatus of any of aspects 28 to 31, where the response indicates support for at least one of: separated-receiver-based EH, time-switching-based EH, power-splitting-based EH, a duration of an EH session, a periodicity and interval for ET, or at least one waveform supported for ET.

Aspect 33 is the apparatus of any of aspects 28 to 32, where the request comprises an indication of support or a request by the EH-capable UE for one or more of: separated-receiver-based EH, time-switching-based EH, power-splitting-based EH, a duration of an EH session, or a set of one or more waveforms for ET, and where the response indicates the support for one or more of: the separated-receiver-based EH indicated in the request, the time-switching-based EH indicated in the request, the power-splitting-based EH indicated in the request, an EH session of the duration indicated in the request, or at least one waveform in the set of one or more waveforms indicated in the request.

Aspect 34 is the apparatus of any of aspects 28 to 32, where the at least one processor is further configured to transmit an indication that the apparatus is not available for a period of time.

Aspect 35 is a method of wireless communication for implementing any of aspects 1 to 34.

Aspect 36 is an apparatus for wireless communication including means for implementing any of aspects 1 to 34.

Aspect 37 is a computer-readable medium storing computer executable code, where the code when executed by a processor causes the processor to implement any of aspects 1 to 34.

What is claimed is:

1. An apparatus for wireless communication at an energy-harvesting (EH) capable user equipment (UE), comprising:
a memory; and
at least one processor coupled to the memory and configured to:
transmit a request for initiating a radio frequency (RF) energy-harvesting (EH) operation;
receive one or more responses to the request; and
receive RF energy transmitted by at least one RF ET node selected based on criteria related to one or more of an RF ET node characteristic, an RF ET node connection quality characteristic, a distance characteristic, or a mobility characteristic.

2. The apparatus of claim 1, wherein the at least one processor is further configured to:
select, at the EH-capable UE, the at least one RF ET node based on the criteria.

3. The apparatus of claim 1, wherein the at least one processor is further configured to:
receive an indication from a network to receive the RF energy from the at least one RF ET node.

4. The apparatus of claim 1, wherein:
the criteria relates to the RF ET node characteristic;
the request comprises an indication of support or a request by the EH-capable UE for one or more of:
separated-receiver-based EH,
time-switching-based EH,
power-splitting-based EH,
a duration of an EH session, or
a set of one or more waveforms for ET; and
the response comprises an indication of at least one RF ET node characteristic related to support for one or more of:
the separated-receiver-based EH indicated in the request,
the time-switching-based EH indicated in the request,
the power-splitting-based EH indicated in the request,
an EH session of the duration indicated in the request, or
at least one waveform in the set of one or more waveforms indicated in the request.

5. The apparatus of claim 4, wherein the set of one or more waveforms includes one or more of a deterministic signal, a circularly symmetric complex Gaussian random signal, or an improper complex Gaussian random signal.

6. The apparatus of claim 4, wherein the response to the request includes an indication that a particular RF ET node is not available and an indication of a time after which an additional request may be transmitted by the EH-capable UE.

7. The apparatus of claim 1, wherein the criteria relates to the connection quality characteristic and is based on at least one of:
a channel power threshold for ET,
an established connection with the EH-capable UE, or
a type of communication between the at least one RF ET node and the EH-capable UE.

8. The apparatus of claim 7, wherein the channel power threshold for ET is a first reference signal received power (RSRP) threshold that is different from a second RSRP threshold for SL communication.

9. The apparatus of claim 7, wherein the at least one RF ET node comprises only RF ET nodes in communication with the EH-capable UE at a time of the request.

10. The apparatus of claim 7, wherein the criteria relates to the type of communication between the RF ET node and the EH-capable UE and is based on a data traffic density threshold.

11. The apparatus of claim 1, wherein the criteria relates to the distance characteristic and is based on a threshold distance between the EH-capable UE and the at least one RF ET node, and wherein a distance between the EH-capable UE and an RF ET node is based on one or more of:
a positioning procedure,
measurement of a reference signal from the RF ET node,
known positions of the EH-capable UE and the RF ET node,
at least one zone ID indicated in sidelink control information, or
a location management function.

12. The apparatus of claim 11, wherein the at least one zone ID comprises at least one zone ID associated with the at least one RF ET node that, in addition to a zone ID associated with the EH-capable UE, is used to identify that the RF ET node is within the threshold distance from the EH-capable UE.

13. The apparatus of claim 1, wherein the at least one processor is further configured to select the at least one RF ET node by:
determining that a set of zone IDs associated with a set of RF ET nodes including the at least one RF ET node indicates that the set of RF ET nodes is within a first threshold distance; and
determining that the at least one RF ET node is within a second smaller threshold distance via a second distance determination procedure.

14. The apparatus of claim 1, wherein the criteria relates to the mobility characteristic and is based on at least one of:
a mobility state of the at least one RF ET node,
a mobility state of the EH-capable UE, or
a relative mobility state of the at least one RF ET node and the EH-capable UE.

15. An apparatus for wireless communication at a base station, comprising:
a memory; and
at least one processor coupled to the memory and configured to:
receive a request to initiate a radio frequency (RF) energy-harvesting (EH) operation for an EH capable user equipment (UE);
select at least one RF ET node to transfer RF energy to the EH-capable UE based on criteria related to one or more of an RF ET node characteristic, an RF ET node connection quality characteristic, a distance characteristic, or a mobility characteristic; and
indicate for the selected at least one RF ET node to transmit the RF energy to the EH-capable UE.

16. The apparatus of claim 15, wherein:
the criteria relates to the RF ET node characteristic;
the request comprises an indication of support or a request by the EH-capable UE for one or more of:
separated-receiver-based EH,
time-switching-based EH,
power-splitting-based EH,
a duration of an EH session, or
a set of one or more waveforms for ET; and
the at least one processor further is configured to:
receive a response from the at least one RF ET node that comprises an indication of at least one RF ET node characteristic related to support for one or more of:
the separated-receiver-based EH indicated in the request,
the time-switching-based EH indicated in the request,
the power-splitting-based EH indicated in the request,
an EH session of the duration indicated in the request, or
at least one waveform in the set of one or more waveforms indicated in the request.

17. The apparatus of claim 15, wherein the at least one processor is further configured to:
receive a response from an RF ET node that includes an indication that the RF ET node is not available for a period of time.

18. The apparatus of claim 15, wherein the criteria relates to the connection quality characteristic and is based on at least one of:
a channel power threshold for ET,
an established connection with the EH-capable UE, or
a type of communication between the at least one RF ET node and the EH-capable UE.

19. The apparatus of claim 18, wherein the channel power threshold for ET is a first reference signal received power (RSRP) threshold that is different from a second RSRP threshold for SL communication.

20. The apparatus of claim 18, wherein the criteria relates to the type of communication between the RF ET node and the EH-capable UE and is based on a data traffic density threshold.

21. The apparatus of claim 15, wherein the criteria relates to the distance characteristic and is based on a threshold distance between the EH-capable UE and the at least one RF ET node, and wherein a distance between the EH-capable UE and an RF ET node is based on one or more of:
a positioning procedure,
measurement of a reference signal from the RF ET node,
positions of the EH-capable UE and the RF ET node,
at least one zone ID indicated in sidelink control information, or
a location management function.

22. The apparatus of claim 15, wherein the at least one processor is further configured to select the at least one RF ET node based on the criteria related to the distance by:
determining that a set of zone IDs associated with a set of RF ET nodes including the at least one RF ET node indicates that the set of RF ET nodes is within a first threshold distance of the EH-capable UE; and
determining that the at least one RF ET node is within a second smaller threshold distance of the EH-capable UE based on a second distance determination procedure.

23. The apparatus of claim 15, wherein the criteria relates to the mobility characteristic and is based on at least one of:
a mobility state of the at least one RF ET node,
a mobility state of the EH-capable UE, or
a relative mobility state of the at least one RF ET node and the EH-capable UE.

24. An apparatus for wireless communication at a radio frequency (RF) energy-transfer (ET) node, comprising:
a memory; and
at least one processor coupled to the memory and configured to:
receive a request to initiate an RF energy-harvesting (EH) operation for an EH capable user equipment (UE); and
transmit a response indicating a support for the RF EH operation based on an RF ET node characteristic.

25. The apparatus of claim 24, wherein the at least one processor is further configured to:
transmit RF energy to the EH-capable UE.

26. The apparatus of claim 25, wherein the at least one processor is further configured to:
receive an indication from a network to transmit the RF energy to the EH-capable UE.

27. The apparatus of claim 25, wherein the at least one processor is further configured to:
receive an indication from the EH-capable UE to transmit the RF energy to the EH capable UE.

28. The apparatus of claim 24, wherein:
the request comprises an indication of support or a request by the EH-capable UE for one or more of:
separated-receiver-based EH,
time-switching-based EH,
power-splitting-based EH,
a duration of an EH session, or
a set of one or more waveforms for ET; and
the response indicates support for one or more of:
the separated-receiver-based EH indicated in the request,
the time-switching-based EH indicated in the request,
the power-splitting-based EH indicated in the request,
an EH session of the duration indicated in the request, or
at least one waveform in the set of one or more waveforms indicated in the request.

29. The apparatus of claim 24, wherein the at least one processor is further configured to:
transmit an indication that the RF ET node is not available for a period of time.

30. A method of wireless communication for an energy-harvesting (EH) capable user equipment (UE) comprising:
transmitting a request for initiating a radio frequency (RF) energy-harvesting (EH) operation;
receiving one or more responses to the request; and
receiving RF energy transmitted by at least one RF ET node selected based on criteria related to one or more of an RF ET node characteristic, an RF ET node connection quality characteristic, a distance characteristic, or a mobility characteristic.
